(19) United States
(12) Patent Application Publication
(10) Pub. No.: US 2017/0241287 A1
(43) Pub. Date: Aug. 24, 2017

(54) METAL POWDER FOR POWDER METALLURGY, COMPOUND, GRANULATED POWDER, SINTERED BODY, AND HEAT RESISTANT COMPONENT

(71) Applicant: Seiko Epson Corporation, Tokyo (JP)

(72) Inventors: Hidefumi NAKAMURA, Hachinohe (JP); Taku KAWASAKI, Hachinohe (JP)

(21) Appl. No.: 15/420,230

(22) Filed: Jan. 31, 2017

(30) Foreign Application Priority Data
Feb. 19, 2016 (JP) 2016-029511

(51) Int. Cl. F01D 25/00; B22F 3/10; F04D 29/02; B22F 5/04; C22C 19/07; B22F 1/00; B22F 5/00

(52) U.S. Cl. CPC F01D 25/005; B22F 1/0059; B22F 1/0007; B22F 3/10; B22F 5/009; B22F 5/04; C22C 19/07; F04D 29/023; B22F 2301/15; B22F 2302/45; F05D 2300/5024

(57) ABSTRACT

A metal powder for powder metallurgy according to the invention contains Co as a principal component, Cr in a proportion of 25 to 32 mass %, Ni in a proportion of 5 to 15 mass %, Fe in a proportion of 0.5 to 2 mass %, W in a proportion of 4 to 10 mass %, Si in a proportion of 0.3 mass % to 1.5 mass %, and C in a proportion of 0.05 mass % to 0.8 mass %, wherein when one element selected from the group consisting of Ti, V, Y, Zr, Nb, Hf, and Ta is defined as a first element, and one element selected from the group and having a higher group number in the periodic table than that of the first element or having the same group number as that of the first element and a higher period number than that of the first element is defined as a second element, the first element is contained in a proportion of 0.01 to 0.5 mass %, and the second element is contained in a proportion of 0.01 to 0.5 mass %.

### CROSS-REFERENCE TO RELATED APPLICATION

This application claims priority to Japanese Patent Application No. 2016-029511 filed on Feb. 19, 2016. The entire disclosures of Japanese Patent Application No. 2016-029511 is hereby incorporated herein by reference.

### BACKGROUND

1. Technical Field

The present invention relates to a metal powder for powder metallurgy, a compound, a granulated powder, a sintered body, and a heat resistant component.

2. Related Art

In a powder metallurgy method, a composition containing a metal powder and a binder is molded into a desired shape to obtain a molded body, and the obtained molded body is degreased and sintered, whereby a sintered body is produced. In such a process for producing a sintered body, an atomic diffusion phenomenon occurs among particles of the metal powder, whereby the molded body is gradually densified, resulting in sintering.

For example, JP-A-2012-87416 proposes a metal powder for powder metallurgy which contains Zr and Si, with the remainder consisting of at least one element selected from the group consisting of Fe, Co, and Ni, and inevitable elements. According to such a metal powder for powder metallurgy, the sinterability is enhanced by the action of Zr, and a sintered body having a high density can be easily produced. Such a sintered body is getting widely used in various machine components, structural components, etc. recently.

However, depending on the use of a sintered body, further densification is needed in some cases. In such a case, a sintered body is further subjected to an additional treatment such as a hot isostatic pressing treatment (HIP treatment) to increase the density, however, the workload is significantly increased, and also an increase in the cost is inevitable.

Therefore, an expectation for realization of a metal powder capable of producing a sintered body having a high density without performing an additional treatment or the like has increased.

### SUMMARY

An advantage of some aspects of the invention is to provide a metal powder for powder metallurgy, a compound, and a granulated powder, each of which is capable of producing a sintered body having a high density, and a sintered body and a heat resistant component, each of which has a high density.

The advantage can be achieved by the configurations described below.

A metal powder for powder metallurgy according to an aspect of the invention contains Co as a principal component, Cr in a proportion of 25 mass % or more and 32 mass % or less, Ni in a proportion of 5 mass % or more and 15 mass % or less, Fe in a proportion of 0.5 mass % or more and 2 mass % or less, W in a proportion of 4 mass % or more and 10 mass % or less, Si in a proportion of 0.3 mass % or more and 1.5 mass % or less, and C in a proportion of 0.05 mass % or more and 0.8 mass % or less, wherein when one element selected from the group consisting of Ti, V, Y, Zr, Nb, Hf, and Ta is defined as a first element, and one element selected from the group consisting of Ti, V, Y, Zr, Nb, Hf, and Ta, and having a higher group number in the periodic table than that of the first element or having the same group number in the periodic table as that of the first element and a higher period number in the periodic table than that of the first element is defined as a second element, the first element is contained in a proportion of 0.01 mass % or more and 0.5 mass % or less, and the second element is contained in a proportion of 0.01 mass % or more and 0.5 mass % or less.

According to this configuration, the alloy composition is optimized so that the densification during sintering of the metal powder for powder metallurgy can be enhanced. As a result, a metal powder for powder metallurgy capable of producing a sintered body having a high density is obtained without performing an additional treatment.

In the metal powder for powder metallurgy according to the aspect of the invention, it is preferred that B is further contained in a proportion of 0.002 mass % or more and 0.1 mass % or less.

According to this configuration, a metal powder for powder metallurgy capable of producing a sintered body having excellent heat resistance and elongation is obtained.

In the metal powder for powder metallurgy according to the aspect of the invention, it is preferred that when a value obtained by dividing the content E1 of the first element by the mass number of the first element is represented by X1 and a value obtained by dividing the content E2 of the second element by the mass number of the second element is represented by X2, X1/X2 is 0.3 or more and 3 or less.

According to this configuration, when the metal powder for powder metallurgy is fired, a difference in timing between the deposition of a carbide or the like of the first element and the deposition of a carbide or the like of the second element can be optimized. As a result, pores remaining in a molded body can be eliminated as if they were swept out sequentially from the inside, and therefore, pores generated in the sintered body can be minimized. Accordingly, a metal powder for powder metallurgy capable of producing a sintered body having a high density and excellent sintered body properties is obtained.

In the metal powder for powder metallurgy according to the aspect of the invention, it is preferred that the sum of the content of the first element and the content of the second element is 0.05 mass % or more and 0.6 mass % or less.

According to this configuration, the densification of a sintered body to be produced becomes necessary and sufficient.

In the metal powder for powder metallurgy according to the aspect of the invention, it is preferred that the metal powder has an average particle diameter of 0.5 μm or more and 30 μm or less.

According to this configuration, pores remaining in a sintered body are extremely decreased, and therefore, a sintered body having a particularly high density and particularly excellent mechanical properties can be produced.

A compound according to an aspect of the invention includes the metal powder for powder metallurgy according to the aspect of the invention and a binder which binds the particles of the metal powder for powder metallurgy to one another.

According to this configuration, a compound capable of producing a sintered body having a high density is obtained.

A granulated powder according to an aspect of the invention includes the metal powder for powder metallurgy according to the aspect of the invention.

According to this configuration, a granulated powder capable of producing a sintered body having a high density is obtained.

A sintered body according to an aspect of the invention contains Co as a principal component, Cr in a proportion of 25 mass % or more and 32 mass % or less, Ni in a proportion of 5 mass % or more and 15 mass % or less, Fe in a proportion of 0.5 mass % or more and 2 mass % or less, W in a proportion of 4 mass % or more and 10 mass % or less, Si in a proportion of 0.3 mass % or more and 1.5 mass % or less, and C in a proportion of 0.05 mass % or more and 0.8 mass % or less, wherein when one element selected from the group consisting of Ti, V, Y, Zr, Nb, Hf, and Ta is defined as a first element, and one element selected from the group consisting of Ti, V, Y, Zr, Nb, Hf, and Ta, and having a higher group number in the periodic table than that of the first element or having the same group number in the periodic table as that of the first element and a higher period number in the periodic table than that of the first element is defined as a second element, the first element is contained in a proportion of 0.01 mass % or more and 0.5 mass % or less, and the second element is contained in a proportion of 0.01 mass % or more and 0.5 mass % or less.

According to this configuration, a sintered body having a high density is obtained without performing an additional treatment.

A heat resistant component according to an aspect of the invention includes the sintered body according to the aspect of the invention.

According to this configuration, a heat resistant component having a high density and excellent heat resistance is obtained without performing an additional treatment.

In the heat resistant component according to the aspect of the invention, it is preferred that the heat resistant component is a supercharger component, a jet engine component, or a power generation turbine component.

According to this configuration, a supercharger component, a jet engine component, and a power generation turbine component each having a high density and excellent heat resistance are obtained even if the shape thereof is complicated.

### BRIEF DESCRIPTION OF THE DRAWINGS

The invention will be described with reference to the accompanying drawings, wherein like numbers reference like elements.

FIG. 1 is a side view showing a nozzle vane for a turbocharger (a view when a blade section is viewed in a plan view) to which a first embodiment of a heat resistant component according to the invention is applied.

FIG. 2 is a plan view of the nozzle vane shown in FIG. 1.

FIG. 3 is a rear view of the nozzle vane shown in FIG. 1.

FIG. 4 is a perspective view showing a compressor blade to which a second embodiment of a heat resistant component according to the invention is applied.

### DESCRIPTION OF EXEMPLARY EMBODIMENTS

Hereinafter, a metal powder for powder metallurgy, a compound, a granulated powder, a sintered body, and a heat resistant component according to the invention will be described in detail.

### Metal Powder for Powder Metallurgy

First, a metal powder for powder metallurgy according to the invention will be described.

In powder metallurgy, a sintered body having a desired shape can be obtained by molding a composition containing a metal powder for powder metallurgy and a binder into a desired shape, followed by degreasing and sintering. According to such a powder metallurgy technique, an advantage that a sintered body with a complicated and fine shape can be produced in a near-net shape (a shape close to a final shape) as compared with the other metallurgy techniques is obtained.

With respect to the metal powder for powder metallurgy to be used in the powder metallurgy, an attempt to increase the density of a sintered body to be produced by appropriately changing the composition thereof has been made. However, in the sintered body, pores are liable to be generated, and therefore, in order to obtain mechanical properties comparable to those of ingot materials, it was necessary to further increase the density of the sintered body.

Therefore, in the past, the obtained sintered body was further subjected to an additional treatment such as a hot isostatic pressing treatment (HIP treatment) to increase the density in some cases. However, such an additional treatment requires much time, labor, and cost, and therefore becomes an obstacle to the expansion of the application of the sintered body.

In consideration of the above-mentioned problems, the present inventors have made intensive studies to find conditions for obtaining a sintered body having a high density without performing an additional treatment. As a result, they found that the density of a sintered body can be increased by optimizing the composition of an alloy which forms a metal powder, and thus completed the invention.

Specifically, the metal powder for powder metallurgy according to the invention is a metal powder which contains Cr in a proportion of 25 mass % or more and 32 mass % or less, Ni in a proportion of 5 mass % or more and 15 mass % or less, Fe in a proportion of 0.5 mass % or more and 2 mass % or less, W in a proportion of 4 mass % or more and 10 mass % or less, Si in a proportion of 0.3 mass % or more and 1.5 mass % or less, C in a proportion of 0.05 mass % or more and 0.8 mass % or less, the below-mentioned first element in a proportion of 0.01 mass % or more and 0.5 mass % or less, and the below-mentioned second element in a proportion of 0.01 mass % or more and 0.5 mass % or less, with the remainder consisting of Co and other elements. According to such a metal powder, as a result of optimizing the alloy composition, the densification during sintering can be particularly enhanced. As a result, a sintered body having a high density can be produced without performing an additional treatment.

By increasing the density of a sintered body, a sintered body having excellent mechanical properties is obtained. Such a sintered body can be widely applied also to, for example, machine components, structural components, and the like, to which an external force (load) is applied.

The first element is one element selected from the group consisting of the following seven elements: Ti, V, Y, Zr, Nb, Hf, and Ta, and the second element is one element selected from the group consisting of the above-mentioned seven elements and having a higher group number in the periodic table than that of the first element or one element selected from the group consisting of the above-mentioned seven elements and having the same group number in the periodic table as that of the element selected as the first element and a higher period number in the periodic table than that of the first element.

Hereinafter, the alloy composition of the metal powder for powder metallurgy according to the invention will be described in further detail. In the following description, the “metal powder for powder metallurgy” is sometimes simply referred to as “metal powder”.

### Cr

Cr (chromium) is an element which imparts corrosion resistance and oxidation resistance to a sintered body to be produced. By using the metal powder containing Cr, a sintered body capable of maintaining high mechanical properties over a long period of time is obtained. Due to this, for example, a structural component capable of maintaining its function even if it is exposed to a high temperature can be realized.

The content of Cr in the metal powder is set to 25 mass % or more and 32 mass % or less, but is set to preferably 26 mass % or more and 31 mass % or less, more preferably 27 mass % or more and 30 mass % or less. When the content of Cr is less than the above lower limit, the corrosion resistance of a sintered body to be produced is insufficient depending on the overall composition, and the heat resistance is deteriorated. On the other hand, when the content of Cr exceeds the above upper limit, the sinterability is deteriorated depending on the overall composition, and therefore, it becomes difficult to increase the density of the sintered body. Due to this, it becomes difficult to increase the corrosion resistance (heat resistance) of a sintered body to be produced.

### Ni

Ni (nickel) decreases the speed of progress of pitting corrosion or erosion of a chromium oxide layer formed on the surface of a sintered body and enhances the strength (heat resistance) under a high temperature of the sintered body when it is added along with Cr. Further, by achieving austenitization, the crystalline phase in the sintered body is stabilized even under a high temperature, and therefore, also from such a viewpoint, the heat resistance of the sintered body can be achieved.

The content of Ni in the metal powder is set to 5 mass % or more and 15 mass % or less, but is set to preferably 7 mass % or more and 13 mass % or less, more preferably 9 mass % or more and 11 mass % or less. When the content of Ni is less than the above lower limit, the corrosion resistance or heat resistance is deteriorated. On the other hand, when the content of Ni exceeds the above upper limit, the content of Cr or Co is relatively decreased, and therefore, the corrosion resistance or heat resistance is deteriorated.

### Fe

Fe (iron) imparts high mechanical properties to a sintered body to be produced.

The content of Fe in the metal powder is set to 0.5 mass % or more and 2 mass % or less, but is set to preferably 0.7 mass % or more and 1.7 mass % or less, more preferably 0.8 mass % or more and 1.5 mass % or less. When the content of Fe is less than the above lower limit, the mechanical properties of a sintered body may be deteriorated. On the other hand, when the content of Fe exceeds the above upper limit, the corrosion resistance or oxidation resistance of a sintered body may be deteriorated.

### W

W (tungsten) enhances the heat resistance of a sintered body to be produced. W forms a carbide by binding to C, and it is considered that this carbide enhances the high-temperature strength. Further, by achieving austenitization, the crystalline phase in the sintered body is stabilized even under a high temperature, and therefore, also from such a viewpoint, the heat resistance of the sintered body can be achieved.

The content of W in the metal powder is set to 4 mass % or more and 10 mass % or less, but is set to preferably 5 mass % or more and 9 mass % or less, more preferably 6 mass % or more and 8 mass % or less. When the content of W is less than the above lower limit, the heat resistance of a sintered body may not be able to be sufficiently enhanced. On the other hand, when the content of W exceeds the above upper limit, many intermetallic compounds are formed, and therefore, the sintered body may be embrittled.

### Si

Si (silicon) acts to enhance the corrosion resistance and mechanical properties of a sintered body to be produced. In an alloy, by the addition of Si, while an oxide of a metal element such as Co is reduced, part of Si is oxidized to forma silicon oxide. Examples of the silicon oxide include SiO and SiO₂. Such a silicon oxide suppresses a significant increase in the size of a metal crystal when the metal crystal grows during the sintering of the metal powder. Due to this, in an alloy to which Si is added, the particle diameter of the metal crystal is kept small, and thus, the corrosion resistance and mechanical properties of the sintered body can be further enhanced. In particular, by the substitution of a Si atom with a Co atom as a substitutional element, the crystal structure is slightly distorted, so that the Young's modulus is increased. Therefore, by the addition of Si, excellent mechanical properties, particularly an excellent Young's modulus can be obtained. As a result, a sintered body having higher deformation resistance even under a high temperature is obtained.

The content of Si in the metal powder is set to 0.3 mass % or more and 1.5 mass % or less, but is set to preferably 0.4 mass % or more and 1.2 mass % or less, more preferably 0.5 mass % or more and 1 mass % or less. When the content of Si is less than the above lower limit, the amount of silicon oxide is too small depending on the firing conditions, and therefore, the size of a metal crystal may be liable to be increased during the sintering of the metal powder. On the other hand, when the content of Si exceeds the above upper limit, the amount of silicon oxide is too large depending on the firing conditions, and therefore, a region where silicon oxide is continuously distributed in space is liable to be generated. In this region, the possibility of decreasing the mechanical properties is high.

### C

C (carbon) can particularly enhance the sinterability and can increase the density when it is used in combination with the below-mentioned first element and second element. Specifically, the first element and the second element each form a carbide by binding to C. By dispersedly depositing this carbide, an effect of preventing the significant growth of crystal grains is exhibited. A clear reason for obtaining such an effect has not been known, but one of the reasons therefor is considered to be because the dispersed deposit serves as an obstacle to inhibit the significant growth of crystal grains, and therefore, a variation in the size of crystal grains is suppressed. Accordingly, it becomes difficult to generate pores in a sintered body, and also the increase in the size of crystal grains is prevented, and thus, a sintered body having a high density and excellent mechanical properties is obtained.

The content of C in the metal powder is set to 0.05 mass % or more and 0.8 mass % or less, but is set to preferably 0.2 mass % or more and 0.6 mass % or less, more preferably 0.3 mass % or more and 0.5 mass % or less. When the content of C is less than the above lower limit, crystal grains are liable to grow depending on the overall composition, and therefore, the mechanical properties of the sintered body become insufficient. On the other hand, when the content of C exceeds the above upper limit, the amount of C is too large depending on the overall composition, and therefore, the sinterability is deteriorated instead.

### First Element and Second Element

The first element and the second element each deposit a carbide or an oxide (hereinafter also collectively referred to as “carbide or the like”). It is considered that this deposited carbide or the like inhibits the significant growth of crystal grains when the metal powder is sintered. As a result, as described above, it becomes difficult to generate pores in a sintered body, and also the increase in the size of crystal grains is prevented, and thus, a sintered body having a high density and excellent mechanical properties is obtained.

In addition, although a detailed description will be given later, the deposited carbide or the like promotes the accumulation of silicon oxide at a crystal grain boundary, and as a result, the sintering is promoted and the density is increased while preventing the increase in the size of crystal grains.

The first element and the second element are two elements selected from the group consisting of Ti, V, Y, Zr, Nb, Hf, and Ta, but preferably include an element belonging to group IIIA or group IVA in the long periodic table (Ti, Y, Zr, or Hf). By including an element belonging to group IIIA or group IVA as at least one of the first element and the second element, oxygen contained as an oxide in the metal powder is removed during sintering and the sinterability of the metal powder can be particularly enhanced.

The first element is only required to be one element selected from the group consisting of Ti, V, Y, Zr, Nb, Hf, and Ta as described above, but is preferably an element belonging to group IIIA or group IVA in the long periodic table in the above-mentioned group. An element belonging to group IIIA or group IVA in the above-mentioned group removes oxygen contained as an oxide in the metal powder and therefore can particularly enhance the sinterability of the metal powder. According to this, the concentration of oxygen remaining in the crystal grains after sintering can be decreased. As a result, the content of oxygen in the sintered body can be decreased, and the density can be increased. Further, these elements are elements having high activity, and therefore are considered to cause rapid atomic diffusion. Accordingly, this atomic diffusion acts as a driving force, and thereby a distance between particles of the metal powder is efficiently decreased and a neck is formed between the particles, so that the densification of a molded body is promoted. As a result, the density of the sintered body can be further increased.

On the other hand, the second element is only required to be one element selected from the group consisting of Ti, V, Y, Zr, Nb, Hf, and Ta and different from the first element as described above, but is preferably an element belonging to group VA in the long periodic table in the above-mentioned group. An element belonging to group VA in the above-mentioned group particularly efficiently deposits the above-mentioned carbide or the like, and therefore, can efficiently inhibit the significant growth of crystal grains during sintering. As a result, the formation of fine crystal grains is promoted, and thus, the density of the sintered body can be increased and also the mechanical properties of the sintered body can be enhanced.

Incidentally, by the combination of the first element with the second element composed of the elements as described above, the effects of the respective elements are exhibited without inhibiting each other. Due to this, the metal powder containing such a first element and a second element enables the production of a sintered body having a particularly high density.

More preferably, a combination of an element belonging to group IVA as the first element with Nb as the second element is adopted.

Further, more preferably, a combination of Zr or Hf as the first element with Nb as the second element is adopted.

By adopting such a combination, the above-mentioned effect becomes more prominent.

Among these elements, Zr is a ferrite forming element, and therefore deposits a body-centered cubic lattice phase. This body-centered cubic lattice phase has more excellent sinterability than the other crystal lattice phases, and therefore contributes to the densification of a sintered body.

The content of the first element in the sintered body is set to 0.01 mass % or more and 0.5 mass % or less, but is set to preferably 0.03 mass % or more and 0.2 mass % or less, more preferably 0.05 mass % or more and 0.1 mass % or less. When the content of the first element is less than the above lower limit, the effect of the addition of the first element is weakened depending on the overall composition, and therefore, the density of a sintered body to be produced is not sufficiently increased. On the other hand, when the content of the first element exceeds the above upper limit, the amount of the first element is too large depending on the overall composition, and therefore, the ratio of the above-mentioned carbide or the like is too high, and the densification is deteriorated instead.

The content of the second element in the sintered body is set to 0.01 mass % or more and 0.5 mass % or less, but is set to preferably 0.03 mass % or more and 0.2 mass % or less, more preferably 0.05 mass % or more and 0.1 mass % or less. When the content of the second element is less than the above lower limit, the effect of the addition of the second element is weakened depending on the overall composition, and therefore, the density of a sintered body to be produced is not sufficiently increased. On the other hand, when the content of the second element exceeds the above upper limit, the amount of the second element is too large depending on the overall composition, and therefore, the ratio of the above-mentioned carbide or the like is too high, and the densification is deteriorated instead.

Further, as described above, each of the first element and the second element deposits a carbide or the like, however, in the case where an element belonging to group IIIA or group IVA is selected as the first element as described above and an element belonging to group VA is selected as the second element as described above, it is presumed that when the metal powder is sintered, the timing when a carbide or the like of the first element is deposited and the timing when a carbide or the like of the second element is deposited differ from each other. It is considered that due to the difference in timing when a carbide or the like is deposited in this manner, sintering gradually proceeds so that the generation of pores is prevented, and thus, a dense sintered body is obtained. That is, it is considered that by the existence of both of the carbide or the like of the first element and the carbide or the like of the second element, the increase in the size of crystal grains can be suppressed while increasing the density of the sintered body.

Further, it is preferred to set the ratio of the content of the first element to the content of the second element in consideration of the mass number of the element selected as the first element and the mass number of the element selected as the second element.

Specifically, when a value obtained by dividing the content E1 (mass %) of the first element by the mass number of the first element is represented by an index X1 and a value obtained by dividing the content E2 (mass %) of the second element by the mass number of the second element is represented by an index X2, the ratio (X1/X2) of the index X1 to the index X2 is preferably 0.3 or more and 3 or less, more preferably 0.5 or more and 2 or less, further more preferably 0.75 or more and 1.3 or less. By setting the ratio X1/X2 within the above range, a difference between the timing when a carbide or the like of the first element is deposited and the timing when a carbide or the like of the second element is deposited can be optimized. According to this, pores remaining in a molded body can be eliminated as if they were swept out sequentially from the inside, and therefore, pores generated in a sintered body can be minimized. Therefore, by setting the ratio X1/X2 within the above range, a sintered body having a high density and excellent mechanical properties can be obtained. Further, the balance between the number of atoms of the first element and the number of atoms of the second element is optimized, and therefore, an effect brought about by the first element and an effect brought about by the second element are synergistically exhibited, and thus, a sintered body having a particularly high density can be obtained.

Here, with respect to a specific example of the combination of the first element with the second element, based on the above-mentioned range of the ratio X1/X2, the ratio (E1/E2) of the content E1 (mass %) to the content E2 (mass %) is also calculated.

For example, in the case where the first element is Zr and the second element is Nb, since the mass number of Zr is 91.2 and the mass number of Nb is 92.9, E1/E2 is preferably 0.29 or more and 2.95 or less, more preferably 0.49 or more and 1.96 or less.

In the case where the first element is Hf and the second element is Nb, since the mass number of Hf is 178.5 and the mass number of Nb is 92.9, E1/E2 is preferably 0.58 or more and 5.76 or less, more preferably 0.96 or more and 3.84 or less.

In the case where the first element is Ti and the second element is Nb, since the mass number of Ti is 47.9 and the mass number of Nb is 92.9, E1/E2 is preferably 0.15 or more and 1.55 or less, more preferably 0.26 or more and 1.03 or less.

In the case where the first element is Nb and the second element is Ta, since the mass number of Nb is 92.9 and the mass number of Ta is 180.9, E1/E2 is preferably 0.15 or more and 1.54 or less, more preferably 0.26 or more and 1.03 or less.

In the case where the first element is Y and the second element is Nb, since the mass number of Y is 88.9 and the mass number of Nb is 92.9, E1/E2 is preferably 0.29 or more and 2.87 or less, more preferably 0.48 or more and 1.91 or less.

In the case where the first element is V and the second element is Nb, since the mass number of V is 50.9 and the mass number of Nb is 92.9, E1/E2 is preferably 0.16 or more and 1.64 or less, more preferably 0.27 or more and 1.10 or less.

In the case where the first element is Ti and the second element is Zr, since the mass number of Ti is 47.9 and the mass number of Zr is 91.2, E1/E2 is preferably 0.16 or more and 1.58 or less, more preferably 0.26 or more and 1.05 or less.

In the case where the first element is Zr and the second element is Ta, since the mass number of Zr is 91.2 and the mass number of Ta is 180.9, E1/E2 is preferably 0.15 or more and 1.51 or less, more preferably 0.25 or more and 1.01 or less.

In the case where the first element is Zr and the second element is V, since the mass number of Zr is 91.2 and the mass number of V is 50.9, E1/E2 is preferably 0.54 or more and 5.38 or less, more preferably 0.90 or more and 3.58 or less.

Also in the case of a combination other than the above-mentioned combinations, E1/E2 can be calculated in the same manner as described above.

The sum (E1+E2) of the content E1 of the first element and the content E2 of the second element is preferably 0.05 mass % or more and 0.6 mass % or less, more preferably 0.10 mass % or more and 0.48 mass % or less, further more preferably 0.12 mass % or more and 0.24 mass % or less. By setting the sum of the content of the first element and the content of the second element within the above range, the densification of a sintered body to be produced becomes necessary and sufficient.

When the ratio of the sum of the content of the first element and the content of the second element to the content of Si is represented by (E1+E2)/Si, (E1+E2)/Si is preferably 0.03 or more and 2 or less, more preferably 0.05 or more and 1 or less, furthermore preferably 0.1 or more and 0.5 or less. By setting the ratio (E1+E2)/Si within the above range, a decrease in the toughness or the like when Si is added is sufficiently compensated by the addition of the first element and the second element. As a result, a sintered body which has excellent mechanical properties such as toughness in spite of having a high density and also has excellent corrosion resistance attributed to Si is obtained.

In addition, it is considered that by the addition of appropriate amounts of the first element and the second element, the carbide or the like of the first element and the carbide or the like of the second element act as “nuclei”, and therefore, silicon oxide is accumulated at a crystal grain boundary in the sintered body. By the accumulation of silicon oxide at a crystal grain boundary, the concentration of oxides inside the crystal grain is decreased, and therefore, sintering is promoted. As a result, it is considered that the densification of the sintered body is further promoted.

The deposited silicon oxide easily moves to the triple point of a crystal grain boundary during the accumulation, and therefore, the crystal growth is suppressed at this point (a flux pinning effect). As a result, the significant growth of crystal grains is suppressed, and thus, a sintered body having finer crystals is obtained. Such a sintered body has particularly high mechanical properties.

Further, when the ratio of the sum of the content of the first element and the content of the second element to the content of C is represented by (E1+E2)/C, (E1+E2)/C is preferably 0.05 or more and 3 or less, more preferably 0.1 or more and 2 or less, further more preferably 0.2 or more and 1 or less. By setting the ratio (E1+E2)/C within the above range, an increase in the hardness and a decrease in the toughness when C is added, and an increase in the density brought about by the addition of the first element and the second element can be both achieved. As a result, a metal powder capable of producing a sintered body which has excellent mechanical properties such as tensile strength and toughness is obtained.

In the sintered body, it is only necessary that two elements selected from the group consisting of Ti, V, Y, Zr, Nb, Hf, and Ta are contained, however, an element which is selected from this group and is different from the two elements may be further contained. That is, in the sintered body, three or more elements selected from the above-mentioned group may be contained. According to this, although it varies depending on the elements to be combined, the above-mentioned effect can be further enhanced.

### Other Element

The metal powder for powder metallurgy according to the invention may contain, other than the above-mentioned elements, at least one element of B, Mn, and S as needed. These elements may be inevitably contained therein.

B strengthens the crystal grain boundary and improves the high-temperature strength and ductility of a sintered body.

The content of B in the metal powder is not particularly limited, but is preferably 0.002 mass % or more and 0.1 mass % or less, more preferably 0.004 mass % or more and 0.05 mass % or less, further more preferably 0.006 mass % or more and 0.02 mass % or less. By setting the content of B within the above range, a sintered body having excellent heat resistance and elongation is obtained.

When the content of B is less than the above lower limit, the heat resistance of a sintered body to be produced may be deteriorated or the brittleness thereof may be increased depending on the overall composition. On the other hand, when the content of B exceeds the above upper limit, the heat resistance or ductility may be deteriorated instead.

Mn imparts corrosion resistance and high mechanical properties to a sintered body to be produced in the same manner as Si.

The content of Mn in the metal powder is not particularly limited, but is preferably 0.005 mass % or more and 0.3 mass % or less, more preferably 0.01 mass % or more and 0.1 mass % or less. By setting the content of Mn within the above range, a sintered body having a high density and excellent mechanical properties is obtained. Further, Mn can suppress the increase in brittleness at a high temperature (when glowing).

When the content of Mn is less than the above lower limit, the corrosion resistance and mechanical properties of a sintered body to be produced may not be sufficiently enhanced depending on the overall composition. On the other hand, when the content of Mn exceeds the above upper limit, the corrosion resistance and mechanical properties may be deteriorated instead.

S enhances the machinability of a sintered body to be produced.

The content of S in the metal powder is not particularly limited, but is preferably 0.05 mass % or less, more preferably 0.01 mass % or more and 0.3 mass % or less. By setting the content of S within the above range, the machinability of a sintered body to be produced can be further enhanced without causing a large decrease in the density of the sintered body to be produced.

To the metal powder for powder metallurgy according to the invention, N, P, Se, Te, Pd, or the like may be added other than the above-mentioned elements. In such a case, the contents of these elements are not particularly limited, but the content of each of these elements is preferably 0.05 mass % or less, and also even the total content of these elements is preferably less than 0.2 mass %. These elements may be inevitably contained.

The metal powder for powder metallurgy according to the invention may contain impurities. Examples of the impurities include all elements other than the above-mentioned elements, and specific examples thereof include Li, Be, Na, Mg, K, Ca, Sc, Zn, Ga, Ge, Ag, In, Sn, Sb, Os, Ir, Pt, Au, and Bi. The incorporation amounts of these impurity elements are preferably controlled such that the content of each of the impurity elements is less than the content of each of the above-mentioned essential elements. Further, the incorporation amounts of these impurity elements are preferably set such that the content of each of the impurity elements is less than 0.03 mass %, more preferably less than 0.02 mass %. Further, even the total content of these impurity elements is set to preferably less than 0.3 mass %, more preferably less than 0.2 mass %. These elements do not inhibit the effect as described above as long as the contents thereof are within the above range, and therefore may be intentionally added to the metal powder.

Meanwhile, O (oxygen) may also be intentionally added to or inevitably mixed in the metal powder, however, the amount thereof is preferably about 0.8 mass % or less, more preferably about 0.5 mass % or less. By controlling the amount of oxygen in the metal powder within the above range, the sinterability is enhanced, and thus, a sintered body having a high density and excellent mechanical properties is obtained. Incidentally, the lower limit thereof is not particularly set, but is preferably 0.03 mass % or more from the viewpoint of ease of mass production or the like.

Co is a component (principal component) whose content is the highest in the alloy forming the metal powder for powder metallurgy according to the invention and has a great influence on the properties of the sintered body. The content of Co is not particularly limited, but is preferably 45 mass % or more, more preferably 50 mass % or more.

The compositional ratio of the metal powder for powder metallurgy can be determined by, for example, Iron and steel—Atomic absorption spectrometric method specified in JIS G 1257 (2000), Iron and steel—ICP atomic emission spectrometric method specified in JIS G 1258 (2007), Iron and steel—Method for spark discharge atomic emission spectrometric analysis specified in JIS G 1253 (2002), Iron and steel—Method for X-ray fluorescence spectrometric analysis specified in JIS G 1256 (1997), gravimetric, titrimetric, and absorption spectrometric methods specified in JIS G 1211 to G 1237, or the like. Specifically, for example, an optical emission spectrometer for solids (spark optical emission spectrometer, model: SPECTROLAB, type: LAVMB08A) manufactured by SPECTRO Analytical Instruments GmbH or an ICP device (model: CIROS-120) manufactured by Rigaku Corporation can be used.

Incidentally, the methods specified in JIS G 1211 to G 1237 are as follows.

JIS G 1211 (2011): Iron and steel—Methods for determination of carbon content

JIS G 1212 (1997): Iron and steel—Methods for determination of silicon content

JIS G 1213 (2001): Iron and steel—Methods for determination of manganese content

JIS G 1214 (1998): Iron and steel—Methods for determination of phosphorus content

JIS G 1215 (2010): Iron and steel—Methods for determination of sulfur content

JIS G 1216 (1997): Iron and steel—Methods for determination of nickel content

JIS G 1217 (2005): Iron and steel—Methods for determination of chromium content

JIS G 1218 (1999): Iron and steel—Methods for determination of molybdenum content

JIS G 1219 (1997): Iron and steel—Methods for determination of copper content

JIS G 1220 (1994): Iron and steel—Methods for determination of tungsten content

JIS G 1221 (1998): Iron and steel—Methods for determination of vanadium content

JIS G 1222 (1999): Iron and steel—Methods for determination of cobalt content

JIS G 1223 (1997): Iron and steel—Methods for determination of titanium content

JIS G 1224 (2001): Iron and steel—Methods for determination of aluminum content

JIS G 1225 (2006): Iron and steel—Methods for determination of arsenic content

JIS G 1226 (1994): Iron and steel—Methods for determination of tin content

JIS G 1227 (1999): Iron and steel—Methods for determination of boron content

JIS G 1228 (2006): Iron and steel—Methods for determination of nitrogen content

JIS G 1229 (1994): Steel—Methods for determination of lead content

JIS G 1232 (1980): Methods for determination of zirconium in steel

JIS G 1233 (1994): Steel—Method for determination of selenium content

JIS G 1234 (1981): Methods for determination of tellurium in steel

JIS G 1235 (1981): Methods for determination of antimony in iron and steel

JIS G 1236 (1992): Method for determination of tantalum in steel

JIS G 1237 (1997): Iron and steel—Methods for determination of niobium content

Further, when C (carbon) and S (sulfur) are determined, particularly, an infrared absorption method after combustion in a current of oxygen (after combustion in a high-frequency induction heating furnace) specified in JIS G 1211 (2011) is also used. Specifically, a carbon-sulfur analyzer, CS-200 manufactured by LECO Corporation can be used.

Further, when N (nitrogen) and O (oxygen) are determined, particularly, a method for determination of nitrogen content in iron and steel specified in JIS G 1228 (2006) and a method for determination of oxygen content in metallic materials specified in JIS Z 2613 (2006) are also used. Specifically, an oxygen-nitrogen analyzer, TC-300/EF-300 manufactured by LECO Corporation can be used.

The average particle diameter of the metal powder for powder metallurgy according to the invention is preferably 0.5 μm or more and 30 μm or less, more preferably 1 μm or more and 20 μm or less, further more preferably 2 μm or more and 10 μm or less. By using the metal powder for powder metallurgy having such a particle diameter, pores remaining in a sintered body are extremely reduced, and therefore, a sintered body having a particularly high density and particularly excellent mechanical properties can be produced.

The average particle diameter is obtained as a particle diameter when the cumulative amount obtained by cumulating the percentages of the particles from the smaller diameter side reaches 50% in a cumulative particle size distribution on a mass basis obtained by laser diffractometry.

When the average particle diameter of the metal powder for powder metallurgy is less than the above lower limit, the moldability is deteriorated in the case where the shape which is difficult to mold is molded, and therefore, the sintered density may be decreased. On the other hand, when the average particle diameter of the metal powder exceeds the above upper limit, gaps between the particles become larger during molding, and therefore, the sintered density may be decreased also in this case.

The particle size distribution of the metal powder for powder metallurgy is preferably as narrow as possible. Specifically, when the average particle diameter of the metal powder for powder metallurgy is within the above range, the maximum particle diameter of the metal powder is preferably 200 μm or less, more preferably 150 μm or less. By controlling the maximum particle diameter of the metal powder for powder metallurgy within the above range, the particle size distribution of the metal powder for powder metallurgy can be made narrower, and thus, the density of the sintered body can be further increased.

Here, the “maximum particle diameter” refers to a particle diameter when the cumulative amount obtained by cumulating the percentages of the particles from the smaller diameter side reaches 99.9% in a cumulative particle size distribution on a mass basis obtained by laser diffractometry.

When the minor axis of each particle of the metal powder for powder metallurgy is represented by S (μm) and the major axis thereof is represented by L (μm), the average of the aspect ratio defined by S/L is preferably about 0.4 or more and 1 or less, more preferably about 0.7 or more and 1 or less. The metal powder for powder metallurgy having an aspect ratio within this range has a shape relatively close to a spherical shape, and therefore, the packing factor when the metal powder is molded is increased. As a result, the density of the sintered body can be further increased.

Here, the “major axis” is the maximum length in the projected image of the particle, and the “minor axis” is the maximum length in the direction perpendicular to the major axis. Incidentally, the average of the aspect ratio is obtained as the average of the measured aspect ratios of 100 or more particles.

The tap density of the metal powder for powder metallurgy according to the invention is preferably 3.5 g/cm³ or more, more preferably 4 g/cm³ or more. According to the metal powder for powder metallurgy having such a high tap density, when a molded body is obtained, the interparticle packing efficiency is particularly increased. Therefore, a particularly dense sintered body can be obtained in the end.

The specific surface area of the metal powder for powder metallurgy according to the invention is not particularly limited, but is preferably 0.1 m²/g or more, more preferably 0.2 m²/g or more. According to the metal powder for powder metallurgy having such a large specific surface area, a surface activity (surface energy) is increased so that it is possible to easily sinter the metal powder even if less energy is applied. Therefore, when a molded body is sintered, a difference in sintering rate hardly occurs between the inner side and the outer side of the molded body, and thus, the decrease in the sintered density due to the pores remaining inside the molded body can be suppressed.

The metal powder for powder metallurgy according to the invention may be a powder (pre-alloy powder) composed only of particles having a single composition, but may also be a mixed powder (pre-mix powder) obtained by mixing a plurality of types of particles having mutually different compositions. In the case of a pre-mix powder, it is only necessary to satisfy the compositional ratio as described above as a whole. According to this, the pre-mix powder brings about the same effect as described above and enables the production of a sintered body having a high density.

Specific examples of the pre-mix powder include a mixed powder of a C powder and a powder in which C (carbon) is reduced from the above-mentioned compositional ratio, and a mixed powder of a first element powder, a second element powder, and a powder in which the first element and the second element are reduced from the above-mentioned compositional ratio. The combination of a plurality of types of powders in the mixed powder is not particularly limited, and any combination may be adopted.

### Method for Producing Sintered Body

Next, a method for producing a sintered body using such a metal powder for powder metallurgy according to the invention will be described.

The method for producing a sintered body includes (A) a composition preparation step in which a composition for producing a sintered body is prepared, (B) a molding step in which a molded body is produced, (C) a degreasing step in which a degreasing treatment is performed, and (D) a firing step in which firing is performed. Hereinafter, the respective steps will be described sequentially.

### (A) Composition Preparation Step

First, the metal powder for powder metallurgy according to the invention and a binder are prepared, and these materials are kneaded using a kneader, whereby a kneaded material is obtained.

In this kneaded material (an embodiment of the compound according to the invention), the metal powder for powder metallurgy is uniformly dispersed.

The metal powder for powder metallurgy according to the invention is produced by, for example, any of a variety of powdering methods such as an atomization method (such as a water atomization method, a gas atomization method, or a spinning water atomization method), a reducing method, a carbonyl method, and a pulverization method.

Among these, the metal powder for powder metallurgy according to the invention is preferably a metal powder produced by an atomization method, more preferably a metal powder produced by a water atomization method or a spinning water atomization method. The atomization method is a method in which a molten metal (metal melt) is caused to collide with a fluid (liquid or gas) sprayed at a high speed to atomize the metal melt into a fine powder and also to cool the fine powder, whereby a metal powder is produced. By producing the metal powder for powder metallurgy through such an atomization method, an extremely fine powder can be efficiently produced. Further, the shape of the particle of the obtained powder is closer to a spherical shape by the action of surface tension. Due to this, when the metal powder is molded, a molded body having a high packing factor is obtained. That is, a powder capable of producing a sintered body having a high density can be obtained.

In the case where a water atomization method is used as the atomization method, the pressure of water (hereinafter referred to as “atomization water”) to be sprayed to the molten metal is not particularly limited, but is set to preferably about 75 MPa or more and 120 MPa or less (750 kgf/cm² or more and 1200 kgf/cm² or less), more preferably about 90 MPa or more and 120 MPa or less (900 kgf/cm² or more and 1200 kgf/cm² or less).

The temperature of the atomization water is also not particularly limited, but is preferably set to about 1° C. or higher and 20° C. or lower.

The atomization water is often sprayed in a cone shape such that it has a vertex on the falling path of the metal melt and the outer diameter gradually decreases downward. In this case, the vertex angle of the cone formed by the atomization water is preferably about 10° or more and 40° or less, more preferably about 15° or more and 35° or less. According to this, a metal powder for powder metallurgy having a composition as described above can be reliably produced.

Further, by using a water atomization method (particularly, a spinning water atomization method), the metal melt can be cooled particularly quickly. Due to this, a powder having high quality can be obtained in a wide alloy composition range.

The cooling rate when cooling the metal melt in the atomization method is preferably 1×10⁴° C./s or more, more preferably 1×10⁵° C./s or more. By the quick cooling in this manner, a homogeneous metal powder for powder metallurgy can be obtained. As a result, a sintered body having high quality can be obtained.

The thus obtained metal powder for powder metallurgy may be classified as needed. Examples of the classification method include dry classification such as sieving classification, inertial classification, and centrifugal classification, and wet classification such as sedimentation classification.

Examples of the binder include polyolefins such as polyethylene, polypropylene, and ethylene-vinyl acetate copolymers, acrylic resins such as polymethyl methacrylate and polybutyl methacrylate, styrenic resins such as polystyrene, polyesters such as polyvinyl chloride, polyvinylidene chloride, polyamide, polyethylene terephthalate, and polybutylene terephthalate, various resins such as polyether, polyvinyl alcohol, polyvinylpyrrolidone, and copolymers thereof, and various organic binders such as various waxes, paraffins, higher fatty acids (such as stearic acid), higher alcohols, higher fatty acid esters, and higher fatty acid amides. These can be used alone or by mixing two or more types thereof.

The content of the binder is preferably about 2 mass % or more and 20 mass % or less, more preferably about 5 mass % or more and 10 mass % or less with respect to the total amount of the kneaded material. By setting the content of the binder within the above range, a molded body can be formed with good moldability, and also the density is increased, and thus, the stability of the shape of the molded body and the like can be particularly enhanced. Further, according to this, a difference in size between the molded body and the degreased body, that is, so-called a shrinkage ratio is optimized, whereby a decrease in the dimensional accuracy of the finally obtained sintered body can be prevented. That is, a sintered body having a high density and high dimensional accuracy can be obtained.

In the kneaded material, a plasticizer may be added as needed. Examples of the plasticizer include phthalate esters (such as DOP, DEP, and DBP), adipate esters, trimellitate esters, and sebacate esters. These can be used alone or by mixing two or more types thereof.

Further, in the kneaded material, other than the metal powder for powder metallurgy, the binder, and the plasticizer, for example, any of a variety of additives such as a lubricant, an antioxidant, a degreasing accelerator, and a surfactant can be added as needed.

The kneading conditions vary depending on the respective conditions such as the metal composition or the particle diameter of the metal powder for powder metallurgy to be used, the composition of the binder, and the blending amount thereof. However, for example, the kneading temperature can be set to about 50° C. or higher and 200° C. or lower, and the kneading time can be set to about 15 minutes or more and 210 minutes or less.

Further, the kneaded material is formed into a pellet (small particle) as needed. The particle diameter of the pellet is set to, for example, about 1 mm or more and 15 mm or less.

Incidentally, depending on the molding method described below, in place of the kneaded material, a granulated powder may be produced. The kneaded material, the granulated powder, and the like are examples of the composition to be subjected to the molding step described below.

The embodiment of the granulated powder according to the invention is directed to a granulated powder obtained by binding a plurality of metal particles to one another with a binder by subjecting the metal powder for powder metallurgy according to the invention to a granulation treatment.

Examples of the binder to be used for producing the granulated powder include polyolefins such as polyethylene, polypropylene, and ethylene-vinyl acetate copolymers, acrylic resins such as polymethyl methacrylate and polybutyl methacrylate, styrenic resins such as polystyrene, polyesters such as polyvinyl chloride, polyvinylidene chloride, polyamide, polyethylene terephthalate, and polybutylene terephthalate, various resins such as polyether, polyvinyl alcohol, polyvinylpyrrolidone, and copolymers thereof, and various organic binders such as various waxes, paraffins, higher fatty acids (such as stearic acid), higher alcohols, higher fatty acid esters, and higher fatty acid amides. These can be used alone or by mixing two or more types thereof.

Among these, as the binder, a binder containing a polyvinyl alcohol or polyvinylpyrrolidone is preferred. These binder components have a high binding ability, and therefore can efficiently form the granulated powder even in a relatively small amount. Further, the thermal decomposability thereof is also high, and therefore, the binder can be reliably decomposed and removed in a short time during degreasing and firing.

The content of the binder is preferably about 0.2 mass % or more and 10 mass % or less, more preferably about 0.3 mass % or more and 5 mass % or less, furthermore preferably about 0.3 mass % or more and 2 mass % or less with respect to the total amount of the granulated powder. By setting the content of the binder within the above range, the granulated powder can be efficiently formed while preventing significantly large particles from being formed or the metal particles which are not granulated from remaining in a large amount. Further, since the moldability is improved, the stability of the shape of the molded body and the like can be particularly enhanced. Further, by setting the content of the binder within the above range, a difference in size between the molded body and the degreased body, that is, so-called a shrinkage ratio is optimized, whereby a decrease in the dimensional accuracy of the finally obtained sintered body can be prevented.

Further, in the granulated powder, any of a variety of additives such as a plasticizer, a lubricant, an antioxidant, a degreasing accelerator, and a surfactant may be added as needed.

Examples of the granulation treatment include a spray drying method, a tumbling granulation method, a fluidized bed granulation method, and a tumbling fluidized bed granulation method.

In the granulation treatment, a solvent which dissolves the binder is used as needed. Examples of the solvent include inorganic solvents such as water and carbon tetrachloride, and organic solvents such as ketone-based solvents, alcohol-based solvents, ether-based solvents, cellosolve-based solvents, aliphatic hydrocarbon-based solvents, aromatic hydrocarbon-based solvents, aromatic heterocyclic compound-based solvents, amide-based solvents, halogen compound-based solvents, ester-based solvents, amine-based solvents, nitrile-based solvents, nitro-based solvents, and aldehyde-based solvents, and one type or a mixture of two or more types selected from these solvents is used.

The average particle diameter of the granulated powder is not particularly limited, but is preferably about 10 μm or more and 200 μm or less, more preferably about 20 μm or more and 100 μm or less, further more preferably about 25 μm or more and 60 μm or less. The granulated powder having such a particle diameter has favorable fluidity, and can more faithfully reflect the shape of a molding die.

The average particle diameter is obtained as a particle diameter when the cumulative amount obtained by cumulating the percentages of the particles from the smaller diameter side reaches 50% in a cumulative particle size distribution on a mass basis obtained by laser diffractometry.

### (B) Molding Step

Subsequently, the kneaded material or the granulated powder is molded, whereby a molded body having the same shape as that of a target sintered body is produced.

The method for producing a molded body (molding method) is not particularly limited, and for example, any of a variety of molding methods such as a powder compaction molding (compression molding) method, a metal injection molding (MIM) method, an extrusion molding method, and a three-dimensional molding method (3D shaping method) can be used.

The molding conditions in the case of a powder compaction molding method among these methods are preferably such that the molding pressure is about 200 MPa or more and 1000 MPa or less (2 t/cm² or more and 10 t/cm² or less), which vary depending on the respective conditions such as the composition and the particle diameter of the metal powder for powder metallurgy to be used, the composition of the binder, and the blending amount thereof.

The molding conditions in the case of a metal injection molding method are preferably such that the material temperature is about 80° C. or higher and 210° C. or lower, and the injection pressure is about 50 MPa or more and 500 MPa or less (0.5 t/cm² or more and 5 t/cm² or less), which vary depending on the respective conditions.

The molding conditions in the case of an extrusion molding method are preferably such that the material temperature is about 80° C. or higher and 210° C. or lower, and the extrusion pressure is about 50 MPa or more and 500 MPa or less (0.5 t/cm² or more and 5 t/cm² or less), which vary depending on the respective conditions.

The thus obtained molded body is in a state where the binder is uniformly distributed in gaps between the particles of the metal powder.

Specific examples of the three-dimensional molding method include a material extrusion deposition method, a material jetting method, a binder jetting method, and a stereolithography method.

The shape and size of the molded body to be produced are determined in anticipation of shrinkage of the molded body in the subsequent degreasing step and firing step.

### (C) Degreasing Step

Subsequently, the thus obtained molded body is subjected to a degreasing treatment (binder removal treatment), whereby a degreased body is obtained.

Specifically, the binder is decomposed by heating the molded body, whereby the binder is removed from the molded body. In this manner, the degreasing treatment is performed. Examples of the degreasing treatment include a method of heating the molded body and a method of exposing the molded body to a gas capable of decomposing the binder.

In the case of using a method of heating the molded body, the conditions for heating the molded body are preferably such that the temperature is about 100° C. or higher and 750° C. or lower and the time is about 0.1 hours or more and 20 hours or less, and more preferably such that the temperature is about 150° C. or higher and 600° C. or lower and the time is about 0.5 hours or more and 15 hours or less, which slightly vary depending on the composition and the blending amount of the binder. According to this, the degreasing of the molded body can be performed necessarily and sufficiently without sintering the molded body. As a result, it is possible to reliably prevent the binder component from remaining inside the degreased body in a large amount.

The atmosphere when the molded body is heated is not particularly limited, and an atmosphere of a reducing gas such as hydrogen, an atmosphere of an inert gas such as nitrogen or argon, an atmosphere of an oxidative gas such as air, a reduced pressure atmosphere obtained by reducing the pressure of such an atmosphere, or the like can be used.

Examples of the gas capable of decomposing the binder include ozone gas.

Incidentally, by dividing this degreasing step into a plurality of steps in which the degreasing conditions are different, and performing the plurality of steps, the binder in the molded body can be more rapidly decomposed and removed so that the binder does not remain in the molded body.

Further, according to need, the degreased body may be subjected to a machining process such as grinding, polishing, or cutting. The degreased body has a relatively low hardness and relatively high plasticity, and therefore, the machining process can be easily performed while preventing the degreased body from losing its shape. According to such a machining process, a sintered body having high dimensional accuracy can be easily obtained in the end.

### (D) Firing Step

The degreased body obtained in the above step (C) is fired in a firing furnace, whereby a sintered body is obtained.

By this firing, in the metal powder for powder metallurgy, diffusion occurs at the boundary surface between the particles, resulting in sintering. At this time, by the mechanism as described above, the degreased body is rapidly sintered. As a result, a sintered body which is dense and has a high density on the whole is obtained.

The firing temperature varies depending on the composition, the particle diameter, and the like of the metal powder for powder metallurgy used in the production of the molded body and the degreased body, but is set to, for example, about 980° C. or higher and 1450° C. or lower, and preferably set to about 1050° C. or higher and 1350° C. or lower.

Further, the firing time is set to 0.2 hours or more and 7 hours or less, but is preferably set to about 1 hour or more and 6 hours or less.

In the firing step, the firing temperature or the below-described firing atmosphere may be changed in the middle of the step.

By setting the firing conditions within such a range, it is possible to sufficiently sinter the entire degreased body while preventing the sintering from proceeding excessively to cause oversintering and increase the size of the crystal structure. As a result, a sintered body having a high density and particularly excellent mechanical properties can be obtained.

Further, since the firing temperature is a relatively low temperature, it is easy to control the heating temperature in the firing furnace to be a fixed temperature, and therefore, it is also easy to maintain the temperature of the degreased body at a fixed temperature. As a result, a more homogeneous sintered body can be produced.

Further, since the firing temperature as described above is a temperature which can be sufficiently realized using a common firing furnace, and therefore, an inexpensive firing furnace can be used, and also the running cost can be kept low. In other words, in the case where the temperature exceeds the above-mentioned firing temperature, it is necessary to employ an expensive firing furnace using a special heat resistant material, and also the running cost may be increased.

The atmosphere when performing firing is not particularly limited, however, in consideration of prevention of significant oxidation of the metal powder, an atmosphere of a reducing gas such as hydrogen, an atmosphere of an inert gas such as argon, a reduced pressure atmosphere obtained by reducing the pressure of such an atmosphere, or the like is preferably used.

Incidentally, the sintered body may be produced by irradiating the metal powder with an energy beam such as a laser to effect sintering in place of the steps exemplified above, that is, in place of the composition preparation step, the molding step, the degreasing step, and the firing step. In this method, the metal powder which is spread flat is irradiated with an energy beam such as a laser, and the metal powder in the irradiated region is sintered, whereby a sintered body having an arbitrary shape corresponding to the shape of the irradiated region is produced (a selective laser sintering method). According to this, a sintered body can be more easily produced.

The thus obtained sintered body has a high density and excellent mechanical properties. That is, a sintered body produced by molding a composition containing the metal powder for powder metallurgy according to the invention and a binder, followed by degreasing and sintering has a higher relative density than a sintered body obtained by sintering a metal powder in the related art. Therefore, according to the invention, a sintered body having a high density which could not be obtained unless an additional treatment such as an HIP treatment is performed can be realized without performing an additional treatment.

Specifically, according to the invention, for example, the relative density can be expected to be increased by 2% or more as compared with the related art, which slightly varies depending on the composition of the metal powder for powder metallurgy.

As a result, the relative density of the obtained sintered body can be expected to be, for example, 97% or more (preferably 98% or more, more preferably 98.5% or more). The sintered body having a relative density within such a range has excellent mechanical properties comparable to those of ingot materials although it has a shape as close as possible to a desired shape by using a powder metallurgy technique, and therefore, the sintered body can be applied to a variety of machine components, structural components, and the like with virtually no post-processing.

Further, the thus obtained sintered body has a sufficiently high density and excellent mechanical properties even without performing an additional treatment, however, in order to further increase the density and enhance the mechanical properties, a variety of additional treatments may be performed.

As the additional treatment, for example, an additional treatment of increasing the density such as the HIP treatment described above may be performed, and also a variety of quenching treatments, a variety of sub-zero treatments, a variety of tempering treatments, a variety of annealing treatments, and the like may be performed. These additional treatments may be performed alone or two or more treatments thereof may be performed in combination.

In the firing step and a variety of additional treatments described above, a light element in the metal powder (in the sintered body) is volatilized, and the composition of the finally obtained sintered body slightly changes from the composition of the metal powder in some cases.

For example, the content of C in the final sintered body may change within the range of 5% or more and 100% or less (preferably within the range of 30% or more and 100% or less) of the content of C in the metal powder for powder metallurgy, which varies depending on the conditions for the step or the conditions for the treatment.

Also the content of 0 in the final sintered body may change within the range of 1% or more and 50% or less (preferably within the range of 3% or more and 50% or less) of the content of 0 in the metal powder for powder metallurgy, which varies depending on the conditions for the step or the conditions for the treatment.

On the other hand, as described above, the produced sintered body may be subjected to an HIP treatment as part of the additional treatments to be performed as needed. However, the density of the sintered body obtained according to the invention has already been sufficiently increased at the end of the firing step. Therefore, even if the HIP treatment is further performed, densification hardly proceeds any further.

In addition, in the HIP treatment, it is necessary to apply pressure to a material to be treated (sintered body) through a pressure medium, and therefore, the material to be treated may be contaminated, the composition or the physical properties of the material to be treated may unintentionally change accompanying the contamination, or the color of the material to be treated may change accompanying the contamination. Further, by the application of pressure, residual stress is generated or increased in the material to be treated, and a problem such as a change in the shape or a decrease in the dimensional accuracy may occur as the residual stress is released over time.

On the other hand, according to the invention, a sintered body having a sufficiently high density can be produced without performing such an HIP treatment, and therefore, a sintered body having an increased density and also an increased strength can be obtained in the same manner as in the case of performing an HIP treatment. Such a sintered body is less contaminated and discolored, and also an unintended change in the composition or physical properties, or the like occurs less, and also a problem such as a change in the shape or a decrease in the dimensional accuracy occurs less. Therefore, according to the invention, a sintered body having high mechanical strength and dimensional accuracy, and excellent durability can be efficiently produced.

Further, the sintered body produced according to the invention requires almost no additional treatments for enhancing the mechanical properties, and therefore, the composition and the crystal structure tend to become uniform in the entire sintered body. Due to this, the sintered body has high structural anisotropy and therefore has excellent durability against a load from every direction regardless of its shape.

Heat Resistant component

### First Embodiment

The heat resistant component according to the invention can be applied to, for example, a supercharger component. The supercharger component described later is a first embodiment of the heat resistant component according to the invention, and at least part of the component is constituted by an embodiment of the sintered body according to the invention.

Examples of such a supercharger component include a nozzle vane for a turbocharger, a turbine wheel for a turbocharger, a waste gate valve, and a turbine housing. Any of these supercharger components is exposed to a high temperature over a long period of time, and also slides between other components in some cases, and therefore is required to have abrasion resistance. As described above, the sintered body according to the invention has a high density, and therefore has excellent heat resistance and mechanical properties. Due to this, a supercharger component having excellent long-term durability is obtained.

Hereinafter, as an example of the supercharger component, a nozzle vane for a turbocharger (hereinafter also referred to in short as “nozzle vane”). The nozzle vane is used for a variable displacement turbocharger and is a valve body for controlling a supercharging pressure by adjusting the nozzle opening degree.

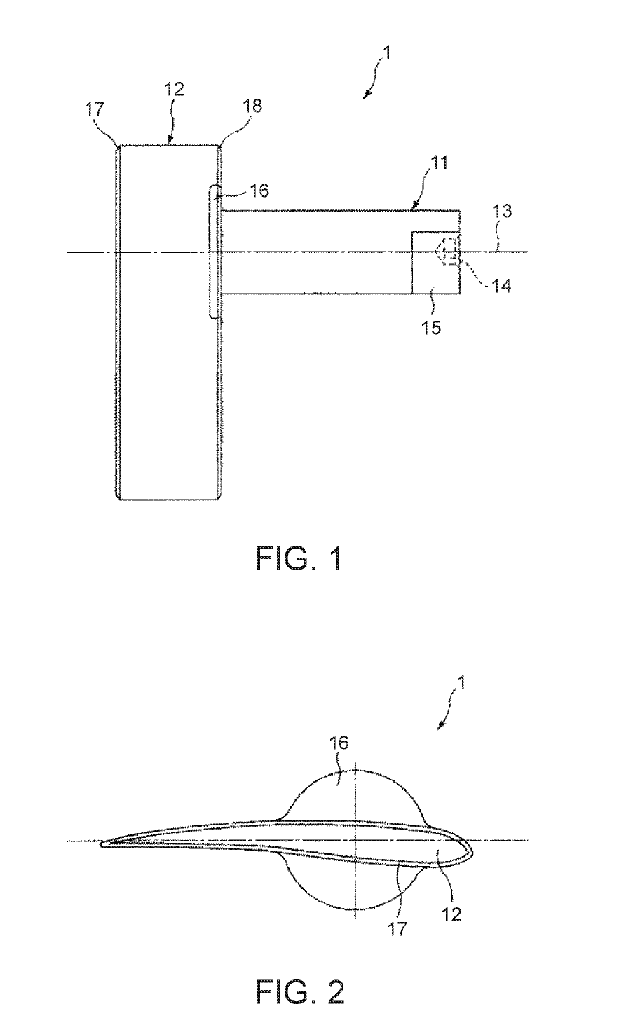

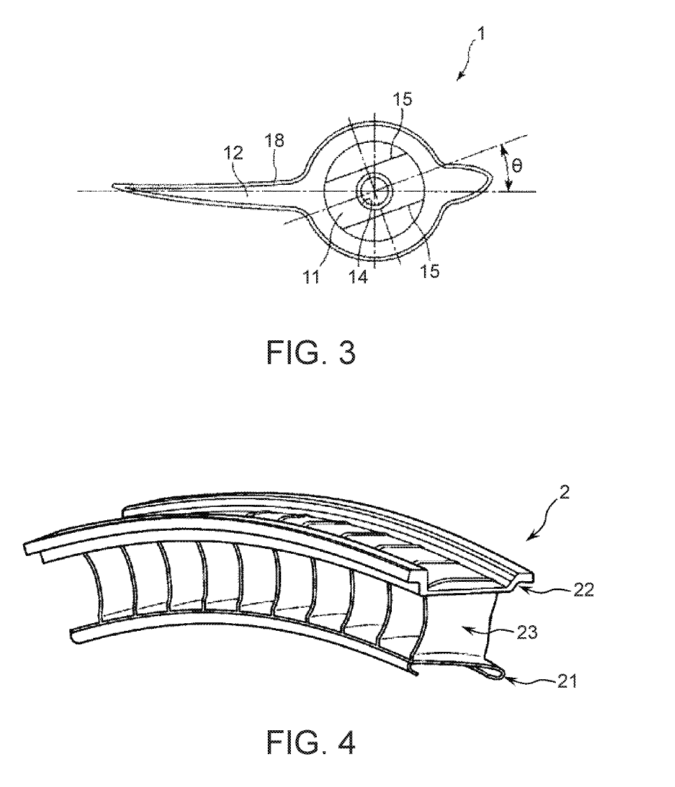

FIG. 1 is a side view showing a nozzle vane for a turbocharger (a view when a blade section is viewed in a plan view) to which the first embodiment of the heat resistant component according to the invention is applied. FIG. 2 is a plan view of the nozzle vane shown in FIG. 1. FIG. 3 is a rear view of the nozzle vane shown in FIG. 1.

A nozzle vane 1 shown in FIG. 1 includes a shaft section 11 and a blade section 12.

The shaft section 11 is configured such that the transverse cross-sectional shape of the main section is a circle with an axial line 13 as the central axis. This shaft section 11 is configured such that a portion on the blade section 12 side (the left side in FIG. 1) is rotatably supported by a nozzle mount (not shown), and a portion on the opposite side to the blade section 12 (the right side in FIG. 1) is fixed to a nozzle plate (not shown). According to this, the blade section 12 is rotated around the axial line 13 and its angle can be changed, and the nozzle opening degree can be adjusted.

Further, a center hole 14 is formed on one end face (an end face on the right side in FIG. 1) of the shaft section 11. This center hole 14 is formed such that the transverse cross-sectional shape thereof is a circle and the center thereof coincides with the axial line 13.

The outer peripheral surface on one end side (the right side in FIG. 1) of the shaft section 11 is provided with a pair of flat sections 15 (a two-side cut section) facing each other through the axial line 13 (see FIG. 3).

Each of such flat sections 15 is used in a state of being in contact with a contact face formed on a lever plate (not shown). A rotation angle around the axial line 13 of the shaft section 11 is regulated, so that a rotation angle around the axial line 13 of the nozzle vane 1 can be highly accurately adjusted. Further, each flat section 15 is formed so as to be inclined at an angle θ with respect to the protruding direction (blade surface) of the blade section 12 (see FIG. 3).

On the other hand, on the other end side (an end portion on the left side in FIG. 1) of the shaft section 11, the blade section 12 is provided. That is, the blade section 12 is provided so as to protrude from the one end portion of the shaft section 11.

Further, on the other end side of the shaft section 11, a flange section 16 protruding outside the shaft section 11 is formed.

Such a blade section 12 has a strip shape extending in a direction perpendicular to the axial line 13 of the shaft section 11 as shown in FIG. 1 in a plan view. Further, the length of the protrusion of the blade section 12 from the shaft section 11 on one end side (the lower side in FIG. 1) is longer than the other end side (the upper side in FIG. 1).

Further, chamfers 17 and 18 are formed in edge portions in both end portions in the width direction (the lateral direction in FIG. 1) in a plan view of the blade section 12.

Further, as shown in FIGS. 2 and 3, the blade section 12 is slightly curved in the thickness direction. In addition, the thickness of the blade section 12 gradually decreases toward each end in the extending direction (protruding direction).

The nozzle vane 1 as described above is constituted by an embodiment of the sintered body according to the invention. The sintered body according to the invention has a high density, and therefore, the nozzle vane 1 has excellent heat resistance and mechanical properties, and thus has excellent abrasion resistance. Further, even if the nozzle vane 1 has a complicated shape, it has high dimensional accuracy. As a result, a supercharger having excellent long-term durability can be realized.

### Second Embodiment

The heat resistant component according to the invention can be applied to, for example, a compressor blade, which is a jet engine component or a power generation turbine component. Such a compressor blade is a second embodiment of the heat resistant component according to the invention, and at least part of the component is constituted by an embodiment of the sintered body according to the invention.

FIG. 4 is a perspective view showing a compressor blade to which the second embodiment of the heat resistant component according to the invention is applied. A compressor blade 2 shown in FIG. 4 includes an inner rim 21 and an outer rim 22 which are mutually concentrically provided, and blade sections 23 which are provided therebetween and arranged in the circumferential direction of the inner rim 21. The inner rim 2l and the outer rim 22 each have an annular shape. Further, the blade section 23 has a plate shape including a curved surface. The blade tips (end faces) of each blade section 23 are bonded to the outer peripheral surface of the inner rim 21 and the inner peripheral surface of the outer rim 22. Incidentally, FIG. 4 is a view illustrating a cut-out portion of the compressor blade 2.

Such a compressor blade 2 is one of the components constituting a jet engine or a power generation gas turbine, and by receiving a gas by the blade sections 23, a turbine shaft provided on the inner side of the inner rim 21 is rotated. According to this, a compressor can compress the gas in the jet engine or the power generation gas turbine.

The inner rim 21, the outer rim 22, and the blade section 23 may be mutually different members, however, in the compressor blade 2 shown in FIG. 4, the inner rim 21, the outer rim 22, and the blade section 23 are integrated with one another. Due to this, the relative positional accuracy of the respective members is high, and excellent performance as the compressor blade is exhibited. Then, by constituting the entire compressor blade 2 by an embodiment of the sintered body according to the invention, the compressor blade 2 having excellent dimensional accuracy is obtained.

Further, in general, the compressor blade is required to have a three-dimensional shape such that the shape of the blade section is thinner and also includes a curved surface by the necessity to improve the aerodynamic performance.

In order to cope with such a problem, the entire compressor blade 2 is constituted by a sintered body produced by a powder metallurgy method, and therefore, even if the blade sections 23 each having a thin and complicated three-dimensional shape are included, the compressor blade 2 having high dimensional accuracy can be realized.

Further, the sintered body according to this embodiment has a high density and excellent heat resistance, and therefore, also contributes to the improvement of the mechanical properties of the compressor blade 2. That is, the compressor blade is generally a component forming an air flow channel, and therefore is required to have sufficient fatigue strength against vibration, abrasion resistance, and the like even under a high temperature.

In order to cope with such a problem, the compressor blade 2 is constituted by the sintered body according to this embodiment, and therefore has a high density and excellent heat resistance, and also has sufficient abrasion resistance. Therefore, the compressor blade 2 having excellent long-term durability is obtained.

Moreover, the production is performed using any of a variety of molding methods, and therefore, in the production of the compressor blade 2, almost no post-processing after sintering is needed, or the processing amount is reduced. In addition, as described above, the density is increased, and therefore, an additional treatment such as an HIP treatment is also not needed. Due to this, the production cost is reduced, and also the occurrence of a defect caused by a post-processing mark can be minimized.

Hereinabove, the metal powder for powder metallurgy, the compound, the granulated powder, the sintered body, and the heat resistant component according to the invention have been described with reference to preferred embodiments, however, the invention is not limited thereto.

For example, the sintered body according to the invention is used for components for transport machinery such as components for automobiles, components for bicycles, components for railroad cars, components for ships, components for airplanes, and components for space transport machinery (such as rockets), components for electronic devices such as components for personal computers and components for mobile phone terminals, components for electrical devices such as refrigerators, washing machines, and cooling and heating machines, components for machines such as machine tools and semiconductor production devices, components for plants such as atomic power plants, thermal power plants, hydroelectric power plants, oil refinery plants, and chemical complexes, components for timepieces, ornaments such as metallic tableware, jewels, and frames for glasses, medical devices such as surgical instruments, artificial bones, artificial teeth, artificial dental roots, and components for orthodontics, and all other sorts of structural components.

Further, the heat resistant component according to the invention can be applied to, for example, a variety of components associated with power generation such as components for nuclear power plants and components for gas turbines, components for a variety of engines such as components for automobile engines and components for rocket engines, components for boilers, components for heat exchangers, components for exhaust gas treatment facilities, components for heating furnaces, components for fuel cells, and all sorts of heat resistant components such as heat resistant bolts, heat resistance springs, and heat resistant valves, other than the above-mentioned supercharger component, jet engine component, and power generation turbine component.

### EXAMPLES

Next, Examples of the invention will be described.

1. Production of Sintered Body (Zr—Nb based)

### Sample No. 1

(1) First, a metal powder having a composition shown in Table 1 produced by a water atomization method was prepared.

The composition of the powder shown in Table 1 was identified and quantitatively determined by an inductively coupled high-frequency plasma optical emission spectrometry (ICP analysis method). In the ICP analysis, an ICP device (model: CIROS-120) manufactured by Rigaku Corporation was used. Further, in the identification and quantitative determination of C, a carbon-sulfur analyzer (CS-200) manufactured by LECO Corporation was used. Further, in the identification and quantitative determination of O, an oxygen-nitrogen analyzer (TC-300/EF-300) manufactured by LECO Corporation was used.

(2) Subsequently, the metal powder and a mixture (organic binder) of polypropylene and a wax were weighed at a mass ratio of 9:1 and mixed with each other, whereby a mixed raw material was obtained.

(3) Subsequently, this mixed raw material was kneaded using a kneader, whereby a compound was obtained.

(4) Subsequently, this compound was molded using an injection molding device under the following molding conditions, whereby a molded body was produced.

Molding Conditions
Material temperature: 150° C.
Injection pressure: 11 MPa (110 kgf/cm²)

(5) Subsequently, the obtained molded body was subjected to a heat treatment (degreasing treatment) under the following degreasing conditions, whereby a degreased body was obtained.

Degreasing Conditions
Degreasing temperature: 500° C.
Degreasing time: 1 hour (retention time at the degreasing temperature)
Degreasing atmosphere: nitrogen atmosphere

(6) Subsequently, the obtained degreased body was fired under the following firing conditions, whereby a sintered body was obtained. The shape of the sintered body was determined to be a cylinder with a diameter of 10 mm and a thickness of 5 mm.

Firing Conditions
Firing temperature: 1250° C.
Firing time: 3 hours (retention time at the firing temperature)
Firing atmosphere: argon atmosphere

### Sample Nos. 2 to 19

Sintered bodies were obtained in the same manner as the method for producing the sintered body of sample No. 1 except that the composition and the like of the metal powder for powder metallurgy were changed as shown in Table 1, respectively. The sintered body of sample No. 19 was obtained by performing an HIP treatment under the following conditions after firing. Further, the sintered bodies of sample Nos. 8 and 9 were obtained by using the metal powder produced by a gas atomization method, respectively, and denoted by “gas” in the column of Remarks in Table 1.

HIP Treatment Conditions
Heating temperature: 1100° C.
Heating time: 2 hours
Applied pressure: 100 MPa

TABLE 1

| | | Metal powder for powder metallurgy | | | | | | | | | |
|---|---|---|---|---|---|---|---|---|---|---|---|
| | | Alloy composition | | | | | | | | | |
| | | | | | | E1 | E2 | | | | |
| Sample | | Cr | Ni | Si | C | (Zr) | (Nb) | Fe | W | B | Co |
| No. | — | Mass % | | | | | | | | | |
| No. 1 | Example | 29.00 | 10.00 | 0.88 | 0.351 | 0.08 | 0.07 | 1.00 | 7.00 | 0.010 | Remainder |
| No. 2 | Example | 28.94 | 10.30 | 0.64 | 0.408 | 0.07 | 0.05 | 1.19 | 6.96 | 0.009 | Remainder |
| No. 3 | Example | 29.01 | 10.21 | 0.77 | 0.409 | 0.05 | 0.08 | 1.16 | 7.26 | 0.007 | Remainder |
| No. 4 | Example | 28.12 | 9.46 | 0.82 | 0.261 | 0.03 | 0.03 | 0.95 | 7.48 | 0.005 | Remainder |
| No. 5 | Example | 27.87 | 11.13 | 0.74 | 0.305 | 0.09 | 0.10 | 1.56 | 6.57 | 0.006 | Remainder |
| No. 6 | Example | 30.49 | 8.87 | 0.51 | 0.489 | 0.11 | 0.04 | 0.84 | 8.64 | 0.003 | Remainder |
| No. 7 | Example | 29.68 | 9.75 | 0.94 | 0.231 | 0.04 | 0.11 | 1.42 | 7.15 | 0.005 | Remainder |
| No. 8 | Example | 29.77 | 10.51 | 0.76 | 0.523 | 0.23 | 0.10 | 1.02 | 7.05 | 0.000 | Remainder |
| No. 9 | Example | 30.12 | 10.72 | 0.45 | 0.426 | 0.07 | 0.24 | 1.23 | 7.89 | 0.008 | Remainder |
| No. 10 | Comp. | 29.45 | 10.15 | 0.91 | 0.413 | 0.00 | 0.08 | 1.05 | 7.32 | 0.005 | Remainder |
| | Ex. | | | | | | | | | | |
| No. 11 | Comp. | 28.75 | 9.96 | 0.78 | 0.389 | 0.05 | 0.00 | 1.29 | 6.87 | 0.003 | Remainder |
| | Ex. | | | | | | | | | | |
| No. 12 | Comp. | 29.65 | 10.46 | 0.74 | 0.274 | 0.00 | 0.00 | 0.88 | 7.04 | 0.002 | Remainder |
| | Ex. | | | | | | | | | | |
| No. 13 | Comp. | 29.11 | 10.36 | 0.86 | 0.563 | 0.58 | 0.08 | 0.97 | 7.66 | 0.005 | Remainder |
| | Ex. | | | | | | | | | | |
| No. 14 | Comp. | 29.01 | 9.76 | 0.64 | 0.345 | 0.07 | 0.57 | 1.46 | 7.74 | 0.006 | Remainder |
| | Ex. | | | | | | | | | | |
| No. 15 | Comp. | 30.67 | 10.06 | 0.13 | 0.368 | 0.08 | 0.07 | 1.06 | 8.15 | 0.004 | Remainder |
| | Ex. | | | | | | | | | | |
| No. 16 | Comp. | 28.69 | 11.23 | 1.89 | 0.063 | 0.05 | 0.08 | 0.75 | 7.11 | 0.005 | Remainder |
| | Ex. | | | | | | | | | | |
| No. 17 | Comp. | 29.15 | 10.23 | 0.64 | 0.025 | 0.01 | 0.01 | 0.97 | 7.05 | 0.006 | Remainder |
| | Ex. | | | | | | | | | | |
| No. 18 | Comp. | 28.78 | 10.14 | 0.76 | 0.956 | 0.21 | 0.07 | 1.35 | 6.65 | 0.003 | Remainder |
| | Ex. | | | | | | | | | | |
| No. 19 | Comp. | 29.45 | 10.15 | 0.91 | 0.413 | 0.00 | 0.08 | 1.05 | 7.32 | 0.005 | Remainder |
| | Ex. | | | | | | | | | | |

| | Metal powder for powder metallurgy | | | | | |
|---|---|---|---|---|---|---|
| | | | | | Powder | |
| | | | (E1 + E2)/ | | production | |
| Sample | E1/E2 | E1 + E2 | Si | (E1 + E2)/C | method | Remarks |
| No. | — | Mass % | — | — | — | — |
| No. 1 | 1.14 | 0.15 | 0.17 | 0.43 | Pre-alloy | |
| No. 2 | 1.40 | 0.12 | 0.19 | 0.29 | Pre-alloy | |
| No. 3 | 0.63 | 0.13 | 0.17 | 0.32 | Pre-alloy | |
| No. 4 | 1.00 | 0.06 | 0.07 | 0.23 | Pre-alloy | |
| No. 5 | 0.90 | 0.19 | 0.26 | 0.62 | Pre-alloy | |
| No. 6 | 2.75 | 0.15 | 0.29 | 0.31 | Pre-alloy | |
| No. 7 | 0.36 | 0.15 | 0.16 | 0.65 | Pre-alloy | |
| No. 8 | 2.30 | 0.33 | 0.43 | 0.63 | Pre-alloy | Gas |
| No. 9 | 0.29 | 0.31 | 0.69 | 0.73 | Pre-alloy | Gas |
| No. 10 | 0.00 | 0.08 | 0.09 | 0.19 | Pre-alloy | |
| No. 11 | — | 0.05 | 0.06 | 0.13 | Pre-alloy | |
| No. 12 | — | 0.00 | 0.00 | 0.00 | Pre-alloy | |
| No. 13 | 7.25 | 0.66 | 0.77 | 1.17 | Pre-alloy | |
| No. 14 | 0.12 | 0.64 | 1.00 | 1.86 | Pre-alloy | |
| No. 15 | 1.14 | 0.15 | 1.15 | 0.41 | Pre-alloy | |
| No. 16 | 0.63 | 0.13 | 0.07 | 2.06 | Pre-alloy | |
| No. 17 | 1.00 | 0.02 | 0.03 | 0.80 | Pre-alloy | |
| No. 18 | 3.00 | 0.28 | 0.37 | 0.29 | Pre-alloy | |
| No. 19 | 0.00 | 0.08 | 0.09 | 0.19 | Pre-alloy | HIP |
| | | | | | | treatment |

In Table 1, among the metal powders for powder metallurgy and the sintered bodies of the respective sample Nos., those corresponding to the invention are denoted by “Example”, and those not corresponding to the invention are denoted by “Comp. Ex.” (Comparative Example).

Each sintered body contained very small amounts of impurities, but the description thereof in Table 1 is omitted.

### Sample No. 20

(1) First, a metal powder having a composition shown in Table 2 was produced by a water atomization method in the same manner as in the case of sample No. 1.

(2) Subsequently, the metal powder was granulated by a spray drying method. The binder used at this time was polyvinyl alcohol, which was used in an amount of 1 part by mass with respect to 100 parts by mass of the metal powder. Further, a solvent (ion exchanged water) was used in an amount of 50 parts by mass with respect to 1 part by mass of polyvinyl alcohol. In this manner, a granulated powder having an average particle diameter of 50 μm was obtained.

(3) Subsequently, this granulated powder was subjected to powder compaction molding under the following molding conditions. In this molding, a press molding machine was used. The shape of the molded body to be produced was determined to be a cube with a side length of 20 mm.

Molding Conditions
Material temperature: 90° C.
Molding pressure: 600 MPa (6 t/cm²)

(4) Subsequently, the obtained molded body was subjected to a heat treatment (degreasing treatment) under the following degreasing conditions, whereby a degreased body was obtained.

Degreasing Conditions
Degreasing temperature: 450° C.
Degreasing time: 2 hours (retention time at the degreasing temperature)
Degreasing atmosphere: nitrogen atmosphere

(5) Subsequently, the obtained degreased body was fired under the following firing conditions, whereby a sintered body was obtained.

Firing Conditions
Firing temperature: 1250° C.
Firing time: 3 hours (retention time at the firing temperature)
Firing atmosphere: argon atmosphere

### Sample Nos. 21 to 34

Sintered bodies were obtained in the same manner as in the case of sample No. 20 except that the composition and the like of the metal powder for powder metallurgy were changed as shown in Table 2, respectively. The sintered body of sample No. 34 was obtained by performing an HIP treatment under the following conditions after firing. Further, the sintered bodies of sample Nos. 27 and 28 were obtained by using the metal powder produced by a gas atomization method, respectively, and denoted by “gas” in the column of Remarks in Table 2.

HIP Treatment Conditions
Heating temperature: 1100° C.
Heating time: 2 hours
Applied pressure: 100 MPa

TABLE 2

| | | Metal powder for powder metallurgy | | | | | | | | | |
|---|---|---|---|---|---|---|---|---|---|---|---|
| | | Alloy composition | | | | | | | | | |
| | | | | | | E1 | E2 | | | | |
| Sample | | Cr | Ni | Si | C | (Zr) | (Nb) | Fe | W | B | Co |
| No. | — | Mass % | | | | | | | | | |
| No. 20 | Example | 29.00 | 10.00 | 0.88 | 0.351 | 0.08 | 0.07 | 1.00 | 7.00 | 0.010 | Remainder |
| No. 21 | Example | 28.94 | 10.30 | 0.64 | 0.408 | 0.07 | 0.05 | 1.19 | 6.96 | 0.009 | Remainder |
| No. 22 | Example | 29.01 | 10.21 | 0.77 | 0.409 | 0.05 | 0.08 | 1.16 | 7.26 | 0.007 | Remainder |
| No. 23 | Example | 28.12 | 9.46 | 0.82 | 0.261 | 0.05 | 0.05 | 0.95 | 7.48 | 0.005 | Remainder |
| No. 24 | Example | 27.87 | 11.13 | 0.74 | 0.305 | 0.09 | 0.10 | 1.56 | 6.57 | 0.006 | Remainder |
| No. 25 | Example | 30.49 | 8.87 | 0.51 | 0.489 | 0.11 | 0.03 | 0.84 | 8.64 | 0.003 | Remainder |
| No. 26 | Example | 29.68 | 9.75 | 0.94 | 0.231 | 0.03 | 0.11 | 1.42 | 7.15 | 0.005 | Remainder |
| No. 27 | Example | 29.77 | 10.51 | 0.76 | 0.523 | 0.23 | 0.10 | 1.02 | 7.05 | 0.000 | Remainder |
| No. 28 | Example | 30.12 | 10.72 | 0.45 | 0.426 | 0.07 | 0.24 | 1.23 | 7.89 | 0.008 | Remainder |
| No. 29 | Comp. Ex. | 29.45 | 10.15 | 0.91 | 0.413 | 0.00 | 0.07 | 1.05 | 7.32 | 0.005 | Remainder |
| No. 30 | Comp. Ex. | 28.75 | 9.96 | 0.78 | 0.389 | 0.08 | 0.00 | 1.29 | 6.87 | 0.003 | Remainder |
| No. 31 | Comp. Ex. | 29.65 | 10.46 | 0.74 | 0.274 | 0.00 | 0.00 | 0.88 | 7.04 | 0.002 | Remainder |
| No. 32 | Comp. Ex. | 29.11 | 10.36 | 0.86 | 0.563 | 0.58 | 0.06 | 0.97 | 7.66 | 0.005 | Remainder |
| No. 33 | Comp. Ex. | 29.01 | 9.76 | 0.64 | 0.345 | 0.05 | 0.64 | 1.46 | 7.74 | 0.006 | Remainder |
| No. 34 | Comp. Ex. | 29.45 | 10.15 | 0.91 | 0.413 | 0.00 | 0.07 | 1.05 | 7.32 | 0.005 | Remainder |

| | Metal powder for powder metallurgy | | | | | |
|---|---|---|---|---|---|---|
| | | | | | Powder | |
| | | | (E1 + E2)/ | | production | |
| Sample | E1/E2 | E1 + E2 | Si | (E1 + E2)/C | method | Remarks |
| No. | — | Mass % | — | — | — | — |
| No. 20 | 1.14 | 0.15 | 0.17 | 0.43 | Pre-alloy | Powder |
| | | | | | | compaction |
| No. 21 | 1.40 | 0.12 | 0.19 | 0.29 | Pre-alloy | Powder |
| | | | | | | compaction |
| No. 22 | 0.63 | 0.13 | 0.17 | 0.32 | Pre-alloy | Powder |
| | | | | | | compaction |
| No. 23 | 1.00 | 0.10 | 0.12 | 0.38 | Pre-alloy | Powder |
| | | | | | | compaction |
| No. 24 | 0.90 | 0.19 | 0.26 | 0.62 | Pre-alloy | Powder |
| | | | | | | compaction |
| No. 25 | 3.67 | 0.14 | 0.27 | 0.29 | Pre-alloy | Powder |
| | | | | | | compaction |
| No. 26 | 0.27 | 0.14 | 0.15 | 0.61 | Pre-alloy | Powder |
| | | | | | | compaction |
| No. 27 | 2.30 | 0.33 | 0.43 | 0.63 | Pre-alloy | Powder |
| | | | | | | compaction |
| | | | | | | and gas |
| No. 28 | 0.29 | 0.31 | 0.69 | 0.73 | Pre-alloy | Powder |
| | | | | | | compaction |
| | | | | | | and gas |
| No. 29 | 0.00 | 0.07 | 0.08 | 0.17 | Pre-alloy | Powder |
| | | | | | | compaction |
| No. 30 | — | 0.08 | 0.10 | 0.21 | Pre-alloy | Powder |
| | | | | | | compaction |
| No. 31 | — | 0.00 | 0.00 | 0.00 | Pre-alloy | Powder |
| | | | | | | compaction |
| No. 32 | 9.67 | 0.64 | 0.74 | 1.14 | Pre-alloy | Powder |
| | | | | | | compaction |
| No. 33 | 0.08 | 0.69 | 1.08 | 2.00 | Pre-alloy | Powder |
| | | | | | | compaction |
| No. 34 | 0.00 | 0.07 | 0.08 | 0.17 | Pre-alloy | HIP |
| | | | | | | treatment |

In Table 2, among the metal powders for powder metallurgy and the sintered bodies of the respective sample Nos., those corresponding to the invention are denoted by “Example”, and those not corresponding to the invention are denoted by “Comp. Ex.” (Comparative Example).

Each sintered body contained very small amounts of impurities, but the description thereof in Table 2 is omitted.

### Sample No. 35

(1) First, a pre-mix powder having a composition shown in Table 3 produced by a water atomization method was prepared. The “pre-mix powder” as used herein refers to a mixed powder of a C powder and a powder in which the C (carbon) component was reduced from the compositional ratio shown in Table 3.

(2) Subsequently, the pre-mix powder and a mixture (organic binder) of polypropylene and a wax were weighed at a mass ratio of 9:1 and mixed with each other, whereby a mixed raw material was obtained.

(3) Subsequently, this mixed raw material was kneaded using a kneader, whereby a compound was obtained.

(4) Subsequently, this compound was molded using an injection molding device under the following molding conditions, whereby a molded body was produced.

Molding Conditions
Material temperature: 150° C.
Injection pressure: 11 MPa (110 kgf/cm²)

(5) Subsequently, the obtained molded body was subjected to a heat treatment (degreasing treatment) under the following degreasing conditions, whereby a degreased body was obtained.

Degreasing Conditions
Degreasing temperature: 500° C.
Degreasing time: 1 hour (retention time at the degreasing temperature)
Degreasing atmosphere: nitrogen atmosphere

(6) Subsequently, the obtained degreased body was fired under the following firing conditions, whereby a sintered body was obtained. The shape of the sintered body was determined to be a cylinder with a diameter of 10 mm and a thickness of 5 mm.

Firing Conditions
Firing temperature: 1250° C.
Firing time: 3 hours (retention time at the firing temperature)
Firing atmosphere: argon atmosphere

### Sample Nos. 36 to 49

Sintered bodies were obtained in the same manner as in the case of sample No. 35 except that the composition and the like of the metal powder for powder metallurgy were changed as shown in Table 3, respectively. The sintered body of sample No. 49 was obtained by performing an HIP treatment under the following conditions after firing.

HIP Treatment Conditions
Heating temperature: 1100° C.
Heating time: 2 hours
Applied pressure: 100 MPa

TABLE 3

| | | Metal powder for powder metallurgy | | | | | | | | | |
|---|---|---|---|---|---|---|---|---|---|---|---|
| | | Alloy composition | | | | | | | | | |
| | | | | | | E1 | E2 | | | | |
| Sample | | Cr | Ni | Si | C | (Zr) | (Nb) | Fe | W | B | Co |
| No. | — | Mass % | | | | | | | | | |
| No. 35 | Example | 29.15 | 9.75 | 0.71 | 0.364 | 0.09 | 0.07 | 1.12 | 7.05 | 0.007 | Remainder |
| No. 36 | Example | 28.75 | 10.05 | 0.89 | 0.154 | 0.07 | 0.05 | 1.74 | 7.45 | 0.008 | Remainder |
| No. 37 | Example | 30.89 | 8.65 | 0.63 | 0.745 | 0.05 | 0.09 | 0.77 | 6.12 | 0.004 | Remainder |
| No. 38 | Example | 26.54 | 12.35 | 0.82 | 0.124 | 0.05 | 0.05 | 0.99 | 8.16 | 0.006 | Remainder |
| No. 39 | Example | 31.25 | 7.12 | 0.41 | 0.289 | 0.09 | 0.10 | 1.54 | 7.77 | 0.007 | Remainder |
| No. 40 | Example | 28.85 | 10.47 | 0.51 | 0.487 | 0.12 | 0.03 | 1.24 | 6.68 | 0.005 | Remainder |
| No. 41 | Example | 29.45 | 10.13 | 0.68 | 0.426 | 0.03 | 0.12 | 0.86 | 6.65 | 0.004 | Remainder |
| No. 42 | Example | 29.32 | 10.35 | 0.78 | 0.412 | 0.24 | 0.09 | 1.12 | 7.36 | 0.000 | Remainder |
| No. 43 | Example | 28.41 | 9.02 | 1.12 | 0.675 | 0.08 | 0.26 | 0.93 | 7.78 | 0.002 | Remainder |
| No. 44 | Comp. | 29.54 | 10.51 | 0.85 | 0.406 | 0.00 | 0.05 | 1.02 | 7.23 | 0.004 | Remainder |
| | Ex. | | | | | | | | | | |
| No. 45 | Comp. | 28.64 | 9.87 | 0.75 | 0.368 | 0.07 | 0.00 | 1.25 | 6.74 | 0.005 | Remainder |
| | Ex. | | | | | | | | | | |
| No. 46 | Comp. | 29.76 | 10.54 | 0.68 | 0.289 | 0.00 | 0.00 | 0.85 | 7.16 | 0.003 | Remainder |
| | Ex. | | | | | | | | | | |
| No. 47 | Comp. | 29.41 | 10.65 | 0.84 | 0.478 | 0.63 | 0.06 | 0.92 | 7.14 | 0.005 | Remainder |
| | Ex. | | | | | | | | | | |
| No. 48 | Comp. | 28.78 | 9.65 | 0.68 | 0.356 | 0.07 | 0.64 | 1.44 | 7.42 | 0.007 | Remainder |
| | Ex. | | | | | | | | | | |
| No. 49 | Comp. | 29.54 | 10.51 | 0.85 | 0.406 | 0.00 | 0.05 | 1.02 | 7.23 | 0.004 | Remainder |
| | Ex. | | | | | | | | | | |

Metal powder for powder metallurgy

| | | | | | Powder | |
|---|---|---|---|---|---|---|
| | | | (E1 + E2)/ | | production | |
| Sample | E1/E2 | E1 + E2 | Si | (E1 + E2)/C | method | Remarks |
| No. | — | Mass % | — | — | — | — |
| No. 35 | 1.29 | 0.16 | 0.23 | 0.44 | Pre-mix | |
| No. 36 | 1.40 | 0.12 | 0.13 | 0.78 | Pre-mix | |
| No. 37 | 0.56 | 0.14 | 0.22 | 0.19 | Pre-mix | |
| No. 38 | 1.00 | 0.10 | 0.12 | 0.81 | Pre-mix | |
| No. 39 | 0.90 | 0.19 | 0.46 | 0.66 | Pre-mix | |
| No. 40 | 4.00 | 0.15 | 0.29 | 0.31 | Pre-mix | |
| No. 41 | 0.25 | 0.15 | 0.22 | 0.35 | Pre-mix | |
| No. 42 | 2.67 | 0.33 | 0.42 | 0.80 | Pre-mix | |
| No. 43 | 0.31 | 0.34 | 0.30 | 0.50 | Pre-mix | |
| No. 44 | 0.00 | 0.05 | 0.06 | 0.12 | Pre-mix | |
| No. 45 | — | 0.07 | 0.09 | 0.19 | Pre-mix | |
| No. 46 | — | 0.00 | 0.00 | 0.00 | Pre-mix | |
| No. 47 | 10.50 | 0.69 | 0.82 | 1.44 | Pre-mix | |
| No. 48 | 0.11 | 0.71 | 1.04 | 1.99 | Pre-mix | |
| No. 49 | 0.00 | 0.05 | 0.06 | 0.12 | Pre-mix | HIP |
| | | | | | | treatment |

In Table 3, among the metal powders for powder metallurgy and the sintered bodies of the respective sample Nos., those corresponding to the invention are denoted by “Example”, and those not corresponding to the invention are denoted by “Comp. Ex.” (Comparative Example).

Each sintered body contained very small amounts of impurities, but the description thereof in Table 3 is omitted.

### 2. Evaluation of Sintered Body (Zr—Nb Based)

### 2.1 Evaluation of Relative Density

With respect to the sintered bodies of the respective sample Nos. shown in Tables 1 to 3, the sintered density was measured in accordance with the method for measuring the density of sintered metal materials specified in JIS Z 2501 (2000), and also the relative density of each sintered body was calculated with reference to the true density of the metal powder for powder metallurgy used for producing each sintered body.

The calculation results are shown in Tables 4 to 6.

### 2.2 Evaluation of Hardness

With respect to the sintered bodies of the respective sample Nos. shown in Tables 1 to 3, the Vickers hardness was measured in accordance with the Vickers hardness test method specified in JIS Z 2244 (2009).

Then, the measured hardness was evaluated according to the following evaluation criteria.

### Evaluation Criteria for Vickers Hardness

A: The Vickers hardness is 600 or more.

B: The Vickers hardness is 550 or more and less than 600.

C: The Vickers hardness is 500 or more and less than 550.

D: The Vickers hardness is less than 500.

The evaluation results are shown in Tables 4 to 6.

### 2.3 Evaluation of Tensile Strength, 0.2% Proof Stress, and Elongation

With respect to the sintered bodies of the respective sample Nos. shown in Tables 1 to 3, the tensile strength, 0.2% proof stress, and elongation were measured in accordance with the metal material tensile test method specified in JIS Z 2241 (2011).

Then, the measured values of these physical properties were evaluated according to the following evaluation criteria.

### Evaluation Criteria for Tensile Strength

A: The tensile strength of the sintered body is 850 MPa or more.

B: The tensile strength of the sintered body is 825 MPa or more and less than 850 MPa.

C: The tensile strength of the sintered body is 800 MPa or more and less than 825 MPa.

D: The tensile strength of the sintered body is 775 MPa or more and less than 800 MPa.

E: The tensile strength of the sintered body is 750 MPa or more and less than 775 MPa.

F: The tensile strength of the sintered body is less than 750 MPa.

### Evaluation Criteria for 0.2% Proof Stress

A: The 0.2% proof stress of the sintered body is 525 MPa or more.

B: The 0.2% proof stress of the sintered body is 500 MPa or more and less than 525 MPa.

C: The 0.2% proof stress of the sintered body is 475 MPa or more and less than 500 MPa.

D: The 0.2% proof stress of the sintered body is 450 MPa or more and less than 475 MPa.

E: The 0.2% proof stress of the sintered body is 425 MPa or more and less than 450 MPa.

F: The 0.2% proof stress of the sintered body is less than 425 MPa.

### Evaluation Criteria for Elongation

A: The elongation of the sintered body is 9% or more.

B: The elongation of the sintered body is 8% or more and less than 9%.

C: The elongation of the sintered body is 7% or more and less than 8%.

D: The elongation of the sintered body is 6% or more and less than 7%.

E: The elongation of the sintered body is 5% or more and less than 6%.

F: The elongation of the sintered body is less than 5%.

The above evaluation results are shown in Tables 4 to 6.

TABLE 4

| | | Metal | | | | | |
|---|---|---|---|---|---|---|---|
| | | powder | Evaluation results of sintered body | | | | |
| | | Average | | | | 0.2% | |
| | | particle | Relative | Vickers | Tensile | proof | |
| | | diameter | density | hardness | strength | stress | Elongation |
| Sample No. | — | μm | % | — | — | — | — |
| No. 1 | Example | 4.12 | 99.7 | A | A | A | A |
| No. 2 | Example | 2.86 | 99.6 | A | A | A | A |
| No. 3 | Example | 3.74 | 99.8 | A | A | A | A |
| No. 4 | Example | 5.06 | 99.5 | A | B | B | B |
| No. 5 | Example | 4.55 | 99.6 | A | A | A | B |
| No. 6 | Example | 3.27 | 99.2 | A | B | B | A |
| No. 7 | Example | 1.85 | 99.3 | A | B | B | A |
| No. 8 | Example | 15.4 | 99.0 | A | B | B | B |
| No. 9 | Example | 8.72 | 99.1 | A | B | B | B |
| No. 10 | Comp Ex. | 3.68 | 97.1 | C | C | C | C |
| No. 11 | Comp Ex. | 4.21 | 97.4 | C | B | B | B |
| No. 12 | Comp Ex. | 3.45 | 96.6 | D | E | E | C |
| No. 13 | Comp Ex. | 4.97 | 95.6 | D | D | D | D |
| No. 14 | Comp Ex. | 4.25 | 95.8 | D | D | D | E |
| No. 15 | Comp Ex. | 3.56 | 95.1 | D | E | E | C |
| No. 16 | Comp Ex. | 2.58 | 94.7 | D | F | F | E |
| No. 17 | Comp Ex. | 4.97 | 95.3 | C | D | D | B |
| No. 18 | Comp Ex. | 4.51 | 94.1 | D | E | E | F |
| No. 19 | Comp Ex. | 3.68 | 99.4 | A | A | A | B |

TABLE 5

| | | Metal | | | | | |
|---|---|---|---|---|---|---|---|
| | | powder | Evaluation results of sintered body | | | | |
| | | Average | | | | 0.2% | |
| | | particle | Relative | Vickers | Tensile | proof | |
| | | diameter | density | hardness | strength | stress | Elongation |
| Sample No. | — | μm | % | — | — | — | — |
| No. 20 | Example | 4.12 | 99.6 | A | A | A | A |
| No. 21 | Example | 2.86 | 99.7 | A | A | A | A |
| No. 22 | Example | 3.74 | 99.8 | A | A | A | A |
| No. 23 | Example | 5.06 | 99.6 | A | A | A | A |
| No. 24 | Example | 4.55 | 99.6 | A | A | A | B |
| No. 25 | Example | 3.27 | 99.3 | A | B | B | A |
| No. 26 | Example | 2.21 | 99.2 | A | B | B | A |
| No. 27 | Example | 12.5 | 99.1 | A | B | B | B |
| No. 28 | Example | 9.74 | 99.0 | A | B | B | B |
| No. 29 | Comp Ex. | 3.68 | 97.3 | C | C | C | C |
| No. 30 | Comp Ex. | 4.21 | 97.5 | C | B | B | B |
| No. 31 | Comp Ex. | 3.45 | 96.8 | D | D | D | C |
| No. 32 | Comp Ex. | 4.97 | 95.7 | D | D | D | D |
| No. 33 | Comp Ex. | 4.25 | 96.0 | D | D | D | E |
| No. 34 | Comp Ex. | 3.76 | 99.3 | B | A | A | B |

TABLE 6

| | | Metal | | | | | |
|---|---|---|---|---|---|---|---|
| | | powder | Evaluation results of sintered body | | | | |
| | | Average | | | | 0.2% | |
| | | particle | Relative | Vickers | Tensile | proof | |
| | | diameter | density | hardness | strength | stress | Elongation |
| Sample No. | — | μm | % | — | — | — | — |
| No. 35 | Example | 4.07 | 99.6 | A | A | A | A |
| No. 36 | Example | 3.82 | 99.4 | A | B | B | A |
| No. 37 | Example | 3.78 | 99.3 | A | B | B | B |
| No. 38 | Example | 3.83 | 99.0 | A | B | B | A |
| No. 39 | Example | 4.58 | 99.4 | A | B | B | A |
| No. 40 | Example | 3.66 | 98.7 | B | B | B | A |
| No. 41 | Example | 3.75 | 98.9 | B | B | B | A |
| No. 42 | Example | 3.79 | 98.5 | B | B | B | A |
| No. 43 | Example | 3.82 | 98.6 | B | B | B | B |
| No. 44 | Comp Ex. | 3.76 | 96.5 | C | C | C | C |
| No. 45 | Comp Ex. | 3.92 | 97.0 | C | B | B | B |
| No. 46 | Comp Ex. | 3.56 | 96.1 | D | D | D | C |
| No. 47 | Comp Ex. | 4.77 | 95.0 | D | D | D | E |
| No. 48 | Comp Ex. | 4.21 | 94.8 | D | D | D | E |
| No. 49 | Comp Ex. | 3.76 | 99.1 | B | A | A | B |

As apparent from Tables 4 to 6, it was confirmed that the sintered bodies corresponding to Example each have a higher relative density than the sintered bodies corresponding to Comparative Example (excluding the sintered bodies having undergone the HIP treatment). Further, it was also confirmed that there is a significant difference in properties such as tensile strength, 0.2% proof stress, and elongation between the sintered bodies corresponding to Example and the sintered bodies corresponding to Comparative Example (excluding the sintered bodies having undergone the HIP treatment).

On the other hand, by comparison of the values of the respective physical properties between the sintered bodies corresponding to Example and the sintered bodies having undergone the HIP treatment, it was confirmed that the values of the physical properties are all comparable to each other.

### 3. Production of Sintered Body (Hf—Nb Based)

### Sample Nos. 50 to 63

Sintered bodies were obtained in the same manner as the method for producing the sintered body of sample No. 1 except that the composition and the like of the metal powder for powder metallurgy were changed as shown in Table 7, respectively.

TABLE 7

| | | Metal powder for powder metallurgy | | | | | | | | | |
|---|---|---|---|---|---|---|---|---|---|---|---|
| | | Alloy composition | | | | | | | | | |
| | | | | | | E1 | E2 | | | | |
| Sample | | Cr | Ni | Si | C | (Hf) | (Nb) | Fe | W | B | Co |
| No. | — | | Mass % | | | | | | | | |
| No. 50 | Example | 29.13 | 10.05 | 0.75 | 0.380 | 0.09 | 0.08 | 1.11 | 7.20 | 0.006 | Remainder |
| No. 51 | Example | 28.26 | 9.62 | 0.84 | 0.250 | 0.05 | 0.05 | 1.93 | 7.63 | 0.004 | Remainder |
| No. 52 | Example | 27.67 | 11.34 | 0.63 | 0.330 | 0.09 | 0.10 | 1.52 | 6.45 | 0.007 | Remainder |
| No. 53 | Example | 30.53 | 8.85 | 0.53 | 0.480 | 0.11 | 0.03 | 0.79 | 8.71 | 0.003 | Remainder |
| No. 54 | Example | 29.63 | 9.94 | 0.95 | 0.220 | 0.07 | 0.11 | 1.36 | 7.05 | 0.005 | Remainder |
| No. 55 | Example | 29.81 | 10.43 | 0.76 | 0.540 | 0.25 | 0.09 | 1.05 | 6.95 | 0.000 | Remainder |
| No. 56 | Example | 30.18 | 10.78 | 0.46 | 0.410 | 0.14 | 0.22 | 1.21 | 7.74 | 0.007 | Remainder |
| No. 57 | Comp. | 29.36 | 10.12 | 0.92 | 0.420 | 0.00 | 0.07 | 0.98 | 7.26 | 0.004 | Remainder |
| | Ex. | | | | | | | | | | |
| No. 58 | Comp. | 28.71 | 9.93 | 0.75 | 0.370 | 0.06 | 0.00 | 1.24 | 6.75 | 0.003 | Remainder |
| | Ex. | | | | | | | | | | |
| No. 59 | Comp. | 29.61 | 10.42 | 0.71 | 0.250 | 0.00 | 0.00 | 0.86 | 7.02 | 0.002 | Remainder |
| | Ex. | | | | | | | | | | |
| No. 60 | Comp. | 29.08 | 10.28 | 0.84 | 0.480 | 0.52 | 0.06 | 0.96 | 7.64 | 0.005 | Remainder |
| | Ex. | | | | | | | | | | |
| No. 61 | Comp. | 29.05 | 9.73 | 0.62 | 0.330 | 0.12 | 0.54 | 1.43 | 7.72 | 0.006 | Remainder |
| | Ex. | | | | | | | | | | |
| No. 62 | Comp. | 30.48 | 10.02 | 0.18 | 0.350 | 0.08 | 0.08 | 1.11 | 7.98 | 0.006 | Remainder |
| | Ex. | | | | | | | | | | |
| No. 63 | Comp. | 28.93 | 11.19 | 1.76 | 0.223 | 0.09 | 0.08 | 0.81 | 7.05 | 0.007 | Remainder |
| | Ex. | | | | | | | | | | |

| | | Metal powder for powder metallurgy | | | | | |
|---|---|---|---|---|---|---|---|
| | | | | | | Powder | |
| | | | | (E1 + E2)/ | | production | |
| Sample | | E1/E2 | E1 + E2 | Si | (E1 + E2)/C | method | Remarks |
| No. | — | — | Mass % | — | — | — | — |
| No. 50 | Example | 1.13 | 0.17 | 0.23 | 0.45 | Pre-alloy | |
| No. 51 | Example | 1.00 | 0.10 | 0.12 | 0.40 | Pre-alloy | |
| No. 52 | Example | 0.90 | 0.19 | 0.30 | 0.58 | Pre-alloy | |
| No. 53 | Example | 3.67 | 0.14 | 0.26 | 0.29 | Pre-alloy | |
| No. 54 | Example | 0.64 | 0.18 | 0.19 | 0.82 | Pre-alloy | |
| No. 55 | Example | 2.78 | 0.34 | 0.45 | 0.63 | Pre-alloy | Gas |
| No. 56 | Example | 0.64 | 0.36 | 0.78 | 0.88 | Pre-alloy | Gas |
| No. 57 | Comp. | 0.00 | 0.07 | 0.08 | 0.17 | Pre-alloy | |
| | Ex. | | | | | | |
| No. 58 | Comp. | — | 0.06 | 0.08 | 0.16 | Pre-alloy | |
| | Ex. | | | | | | |
| No. 59 | Comp. | — | 0.00 | 0.00 | 0.00 | Pre-alloy | |
| | Ex. | | | | | | |
| No. 60 | Comp. | 8.67 | 0.58 | 0.69 | 1.21 | Pre-alloy | |
| | Ex. | | | | | | |
| No. 61 | Comp. | 0.22 | 0.66 | 1.06 | 2.00 | Pre-alloy | |
| | Ex. | | | | | | |
| No. 62 | Comp. | 1.00 | 0.16 | 0.89 | 0.46 | Pre-alloy | |
| | Ex. | | | | | | |
| No. 63 | Comp. | 1.13 | 0.17 | 0.10 | 0.76 | Pre-alloy | |
| | Ex. | | | | | | |

In Table 7, among the metal powders for powder metallurgy and the sintered bodies of the respective sample Nos., those corresponding to the invention are denoted by “Example”, and those not corresponding to the invention are denoted by “Comp. Ex.” (Comparative Example).

Each sintered body contained very small amounts of impurities, but the description thereof in Table 7 is omitted.

### Sample Nos. 64 to 70

Sintered bodies were obtained in the same manner as in the case of sample No. 35 except that the composition and the like of the metal powder for powder metallurgy were changed as shown in Table 8, respectively.

TABLE 8

| | | Metal powder for powder metallurgy | | | | | | | | | |
|---|---|---|---|---|---|---|---|---|---|---|---|
| | | Alloy composition | | | | | | | | | |
| | | | | | | E1 | E2 | | | | |
| Sample | | Cr | Ni | Si | C | (Hf) | (Nb) | Fe | W | B | Co |
| No. | — | | Mass % | | | | | | | | |
| No. 64 | Example | 29.11 | 10.06 | 0.77 | 0.418 | 0.08 | 0.05 | 1.06 | 7.22 | 0.006 | Remainder |
| No. 65 | Example | 28.48 | 9.48 | 0.86 | 0.277 | 0.05 | 0.02 | 0.83 | 7.09 | 0.009 | Remainder |
| No. 66 | Example | 27.56 | 11.03 | 0.68 | 0.344 | 0.09 | 0.12 | 1.18 | 6.75 | 0.002 | Remainder |
| No. 67 | Comp. | 29.38 | 10.06 | 0.85 | 0.382 | 0.00 | 0.06 | 0.97 | 7.21 | 0.007 | Remainder |
| | Ex. | | | | | | | | | | |
| No. 68 | Comp. | 28.66 | 9.85 | 0.73 | 0.372 | 0.09 | 0.00 | 1.13 | 6.67 | 0.004 | Remainder |
| | Ex. | | | | | | | | | | |
| No. 69 | Comp. | 29.75 | 10.35 | 0.52 | 0.443 | 0.63 | 0.10 | 1.02 | 7.83 | 0.006 | Remainder |
| | Ex. | | | | | | | | | | |
| No. 70 | Comp. | 28.44 | 9.65 | 0.61 | 0.345 | 0.15 | 0.55 | 1.28 | 7.71 | 0.007 | Remainder |
| | Ex. | | | | | | | | | | |

| | | Metal powder for powder metallurgy | | | | | |
|---|---|---|---|---|---|---|---|
| | | | | | | Powder | |
| | | | | (E1 + E2)/ | | production | |
| Sample | | E1/E2 | E1 + E2 | Si | (E1 + E2)/C | method | Remarks |
| No. | — | — | Mass % | — | — | — | — |
| No. 64 | Example | 1.60 | 0.13 | 0.17 | 0.31 | Pre-mix | |
| No. 65 | Example | 2.50 | 0.07 | 0.08 | 0.25 | Pre-mix | |
| No. 66 | Example | 0.75 | 0.21 | 0.31 | 0.61 | Pre-mix | |
| No. 67 | Comp. | 0.00 | 0.06 | 0.07 | 0.16 | Pre-mix | |
| | Ex. | | | | | | |
| No. 68 | Comp. | — | 0.09 | 0.12 | 0.24 | Pre-mix | |
| | Ex. | | | | | | |
| No. 69 | Comp. | 6.30 | 0.73 | 1.40 | 1.65 | Pre-mix | |
| | Ex. | | | | | | |
| No. 70 | Comp. | 0.27 | 0.70 | 1.15 | 2.03 | Pre-mix | |
| | Ex. | | | | | | |

In Table 8, among the metal powders for powder metallurgy and the sintered bodies of the respective sample Nos., those corresponding to the invention are denoted by “Example”, and those not corresponding to the invention are denoted by “Comp. Ex.” (Comparative Example).

Each sintered body contained very small amounts of impurities, but the description thereof in Table 8 is omitted.

### 4. Evaluation of Sintered Body (Hf—Nb Based)

### 4.1 Evaluation of Relative Density

With respect to the sintered bodies of the respective sample Nos. shown in Tables 7 and 8, the sintered density was measured in accordance with the method for measuring the density of sintered metal materials specified in JIS Z 2501 (2000), and also the relative density of each sintered body was calculated with reference to the true density of the metal powder for powder metallurgy used for producing each sintered body.

The calculation results are shown in Tables 9 and 10.

### 4.2 Evaluation of Hardness

With respect to the sintered bodies of the respective sample Nos. shown in Tables 7 and 8, the Vickers hardness was measured in accordance with the Vickers hardness test method specified in JIS Z 2244 (2009).

Then, the measured hardness was evaluated according to the evaluation criteria described in 2.2.

The evaluation results are shown in Tables 9 and 10.

### 4.3 Evaluation of Tensile Strength, 0.2% Proof Stress, and Elongation

With respect to the sintered bodies of the respective sample Nos. shown in Tables 7 and 8, the tensile strength, 0.2% proof stress, and elongation were measured in accordance with the metal material tensile test method specified in JIS Z 2241 (2011).

Then, the measured values of the physical properties were evaluated according to the evaluation criteria described in 2.3.

The evaluation results are shown in Tables 9 and 10.

TABLE 9

| | | Metal | | | | | |
|---|---|---|---|---|---|---|---|
| | | powder | Evaluation results of sintered body | | | | |
| | | Average | | | | 0.2% | |
| | | particle | Relative | Vickers | Tensile | proof | |
| | | diameter | density | hardness | strength | stress | Elongation |
| Sample No. | — | μm | % | — | — | — | — |
| No. 50 | Example | 4.09 | 99.6 | A | A | A | A |
| No. 51 | Example | 5.15 | 99.4 | A | A | A | A |
| No. 52 | Example | 3.47 | 99.3 | A | A | A | A |
| No. 53 | Example | 3.87 | 99.0 | A | B | A | A |
| No. 54 | Example | 1.65 | 99.1 | A | A | A | B |
| No. 55 | Example | 18.6 | 98.7 | A | A | A | A |
| No. 56 | Example | 11.2 | 98.9 | A | B | B | B |
| No. 57 | Comp. | 3.88 | 96.7 | C | D | D | B |
| | Ex. | | | | | | |
| No. 58 | Comp. | 4.19 | 97.1 | C | C | C | B |
| | Ex. | | | | | | |
| No. 59 | Comp. | 4.09 | 95.8 | D | E | E | D |
| | Ex. | | | | | | |
| No. 60 | Comp. | 5.06 | 95.0 | D | D | D | D |
| | Ex. | | | | | | |
| No. 61 | Comp. | 4.63 | 94.8 | D | D | D | E |
| | Ex. | | | | | | |
| No. 62 | Comp. | 3.57 | 96.5 | C | E | E | D |
| | Ex. | | | | | | |
| No. 63 | Comp. | 3.18 | 94.1 | D | F | F | E |
| | Ex. | | | | | | |

TABLE 10

| | | Metal | | | | | |
|---|---|---|---|---|---|---|---|
| | | powder | Evaluation results of sintered body | | | | |
| | | Average | | | | 0.2% | |
| | | particle | Relative | Vickers | Tensile | proof | |
| | | diameter | density | hardness | strength | stress | Elongation |
| Sample No. | — | μm | % | — | — | — | — |
| No. 64 | Example | 5.87 | 99.4 | A | A | A | A |
| No. 65 | Example | 4.98 | 98.9 | A | A | A | B |
| No. 66 | Example | 4.31 | 99.3 | A | B | B | B |
| No. 67 | Comp. | 5.32 | 96.5 | C | D | D | B |
| | Ex. | | | | | | |
| No. 68 | Comp. | 5.84 | 97.2 | C | C | C | B |
| | Ex. | | | | | | |
| No. 69 | Comp. | 4.53 | 95.2 | D | D | D | D |
| | Ex. | | | | | | |
| No. 70 | Comp. | 4.18 | 94.9 | D | D | D | E |
| | Ex. | | | | | | |

As apparent from Tables 9 and 10, it was confirmed that the sintered bodies corresponding to Example each have a higher relative density than the sintered bodies corresponding to Comparative Example. It was also confirmed that there is a significant difference in properties such as tensile strength, 0.2% proof stress, and elongation between the sintered bodies corresponding to Example and the sintered bodies corresponding to Comparative Example.

### 5. Production of Sintered Body (Ti—Nb Based)

### Sample Nos. 71 to 80

Sintered bodies were obtained in the same manner as the method for producing the sintered body of sample No. 1 except that the composition and the like of the metal powder for powder metallurgy were changed as shown in Table 11, respectively.

TABLE 11

| | | Metal powder for powder metallurgy | | | | | | | | | |
|---|---|---|---|---|---|---|---|---|---|---|---|
| | | Alloy composition | | | | | | | | | |
| | | | | | | E1 | E2 | | | | |
| Sample | | Cr | Ni | Si | C | (Ti) | (Nb) | Fe | W | B | Co |
| No. | — | | Mass % | | | | | | | | |
| No. 71 | Example | 28.25 | 9.52 | 0.83 | 0.268 | 0.05 | 0.05 | 0.92 | 7.34 | 0.006 | Remainder |
| No. 72 | Example | 27.82 | 11.25 | 0.72 | 0.318 | 0.08 | 0.10 | 1.53 | 6.48 | 0.006 | Remainder |
| No. 73 | Example | 30.52 | 8.79 | 0.53 | 0.476 | 0.04 | 0.03 | 0.84 | 8.81 | 0.002 | Remainder |
| No. 74 | Example | 29.81 | 9.81 | 0.95 | 0.221 | 0.03 | 0.11 | 1.24 | 7.08 | 0.005 | Remainder |
| No. 75 | Example | 29.68 | 10.39 | 0.71 | 0.523 | 0.15 | 0.10 | 0.99 | 7.01 | 0.000 | Remainder |
| No. 76 | Example | 30.08 | 10.59 | 0.38 | 0.413 | 0.07 | 0.22 | 1.21 | 7.78 | 0.007 | Remainder |
| No. 77 | Comp. | 29.42 | 10.08 | 0.89 | 0.399 | 0.00 | 0.05 | 1.02 | 7.28 | 0.005 | Remainder |
| | Ex. | | | | | | | | | | |
| No. 78 | Comp. | 28.68 | 9.88 | 0.75 | 0.377 | 0.06 | 0.00 | 1.25 | 6.82 | 0.004 | Remainder |
| | Ex. | | | | | | | | | | |
| No. 79 | Comp. | 29.08 | 10.31 | 0.84 | 0.551 | 0.66 | 0.23 | 0.97 | 7.55 | 0.005 | Remainder |
| | Ex. | | | | | | | | | | |
| No. 80 | Comp. | 28.84 | 9.67 | 0.62 | 0.331 | 0.07 | 0.62 | 1.43 | 7.89 | 0.007 | Remainder |
| | Ex. | | | | | | | | | | |

| | | Metal powder for powder metallurgy | | | | | |
|---|---|---|---|---|---|---|---|
| | | | | | | Powder | |
| | | | | (E1 + E2)/ | | production | |
| Sample | | E1/E2 | E1 + E2 | Si | (E1 + E2)/C | method | Remarks |
| No. | — | — | Mass % | — | — | — | — |
| No. 71 | Example | 1.00 | 0.10 | 0.12 | 0.37 | Pre-alloy | |
| No. 72 | Example | 0.80 | 0.18 | 0.25 | 0.57 | Pre-alloy | |
| No. 73 | Example | 1.33 | 0.07 | 0.13 | 0.15 | Pre-alloy | |
| No. 74 | Example | 0.27 | 0.14 | 0.15 | 0.63 | Pre-alloy | |
| No. 75 | Example | 1.50 | 0.25 | 0.35 | 0.48 | Pre-alloy | |
| No. 76 | Example | 0.32 | 0.29 | 0.76 | 0.70 | Pre-alloy | |
| No. 77 | Comp. | 0.00 | 0.05 | 0.06 | 0.13 | Pre-alloy | |
| | Ex. | | | | | | |
| No. 78 | Comp. | — | 0.06 | 0.08 | 0.16 | Pre-alloy | |
| | Ex. | | | | | | |
| No. 79 | Comp. | 2.87 | 0.89 | 1.06 | 1.62 | Pre-alloy | |
| | Ex. | | | | | | |
| No. 80 | Comp. | 0.11 | 0.69 | 1.11 | 2.08 | Pre-alloy | |
| | Ex. | | | | | | |

In Table 11, among the metal powders for powder metallurgy and the sintered bodies of the respective sample Nos., those corresponding to the invention are denoted by “Example”, and those not corresponding to the invention are denoted by “Comp. Ex.” (Comparative Example).

Each sintered body contained very small amounts of impurities, but the description thereof in Table 11 is omitted.

### 6. Evaluation of Sintered Body (Ti—Nb Based)

### 6.1 Evaluation of Relative Density

With respect to the sintered bodies of the respective sample Nos. shown in Table 11, the sintered density was measured in accordance with the method for measuring the density of sintered metal materials specified in JIS Z 2501 (2000), and also the relative density of each sintered body was calculated with reference to the true density of the metal powder for powder metallurgy used for producing each sintered body.

The calculation results are shown in Table 12.

### 6.2 Evaluation of Hardness

With respect to the sintered bodies of the respective sample Nos. shown in Table 11, the Vickers hardness was measured in accordance with the Vickers hardness test method specified in JIS Z 2244 (2009).

Then, the measured hardness was evaluated according to the evaluation criteria described in 2.2.

The evaluation results are shown in Table 12.

### 6.3 Evaluation of Tensile Strength, 0.2% Proof Stress, and Elongation

With respect to the sintered bodies of the respective sample Nos. shown in Table 11, the tensile strength, 0.2% proof stress, and elongation were measured in accordance with the metal material tensile test method specified in JIS Z 2241 (2011).

Then, the measured values of the physical properties were evaluated according to the evaluation criteria described in 2.3.

The evaluation results are shown in Table 12.

TABLE 12

| | | Metal | | | | | |
|---|---|---|---|---|---|---|---|
| | | powder | Evaluation results of sintered body | | | | |
| | | Average | | | | 0.2% | |
| | | particle | Relative | Vickers | Tensile | proof | |
| | | diameter | density | hardness | strength | stress | Elongation |
| Sample No. | — | μm | % | — | — | — | — |
| No. 71 | Example | 4.25 | 99.1 | A | A | A | A |
| No. 72 | Example | 6.42 | 99.5 | A | A | A | A |
| No. 73 | Example | 3.55 | 98.7 | A | A | A | B |
| No. 74 | Example | 1.77 | 99.0 | A | B | B | A |
| No. 75 | Example | 16.5 | 98.4 | A | B | B | B |
| No. 76 | Example | 7.96 | 98.5 | A | B | B | C |
| No. 77 | Comp. | 4.21 | 96.8 | C | D | D | B |
| | Ex. | | | | | | |
| No. 78 | Comp. | 4.87 | 97.2 | C | C | C | B |
| | Ex. | | | | | | |
| No. 79 | Comp. | 4.05 | 95.7 | C | D | D | D |
| | Ex. | | | | | | |
| No. 80 | Comp. | 4.36 | 95.1 | C | D | D | E |
| | Ex. | | | | | | |

As apparent from Table 12, it was confirmed that the sintered bodies corresponding to Example each have a higher relative density than the sintered bodies corresponding to Comparative Example. It was also confirmed that there is a significant difference in properties such as tensile strength, 0.2% proof stress, and elongation between the sintered bodies corresponding to Example and the sintered bodies corresponding to Comparative Example.

### 7. Production of Sintered Body (Nb—Ta Based)

### Sample Nos. 81 to 90

Sintered bodies were obtained in the same manner as the method for producing the sintered body of sample No. 1 except that the composition and the like of the metal powder for powder metallurgy were changed as shown in Table 13, respectively.

TABLE 13

| | | Metal powder for powder metallurgy | | | | | | | | | |
|---|---|---|---|---|---|---|---|---|---|---|---|
| | | Alloy composition | | | | | | | | | |
| | | | | | | E1 | E2 | | | | |
| Sample | | Cr | Ni | Si | C | (Nb) | (Ta) | Fe | W | B | Co |
| No. | — | | Mass % | | | | | | | | |
| No. 81 | Example | 28.44 | 9.52 | 0.81 | 0.287 | 0.05 | 0.05 | 0.93 | 7.42 | 0.005 | Remainder |
| No. 82 | Example | 27.76 | 11.08 | 0.72 | 0.311 | 0.09 | 0.10 | 1.54 | 6.54 | 0.006 | Remainder |
| No. 83 | Example | 30.39 | 8.75 | 0.49 | 0.481 | 0.04 | 0.03 | 0.81 | 8.47 | 0.003 | Remainder |
| No. 84 | Example | 29.62 | 9.94 | 0.93 | 0.234 | 0.03 | 0.11 | 1.25 | 7.08 | 0.005 | Remainder |
| No. 85 | Example | 28.14 | 10.36 | 0.78 | 0.508 | 0.15 | 0.10 | 0.72 | 6.87 | 0.000 | Remainder |
| No. 86 | Example | 29.94 | 10.58 | 0.41 | 0.418 | 0.07 | 0.24 | 1.05 | 7.74 | 0.007 | Remainder |
| No. 87 | Comp. | 29.41 | 10.45 | 0.97 | 0.415 | 0.00 | 0.05 | 1.08 | 7.77 | 0.005 | Remainder |
| | Ex. | | | | | | | | | | |
| No. 88 | Comp. | 28.45 | 9.85 | 0.75 | 0.368 | 0.06 | 0.00 | 1.18 | 6.94 | 0.003 | Remainder |
| | Ex. | | | | | | | | | | |
| No. 89 | Comp. | 29.08 | 10.28 | 0.88 | 0.554 | 0.64 | 0.09 | 0.94 | 7.72 | 0.005 | Remainder |
| | Ex. | | | | | | | | | | |
| No. 90 | Comp. | 28.75 | 9.87 | 0.46 | 0.354 | 0.05 | 0.69 | 1.42 | 7.68 | 0.006 | Remainder |
| | Ex. | | | | | | | | | | |

| | | Metal powder for powder metallurgy | | | | | |
|---|---|---|---|---|---|---|---|
| | | | | | | Powder | |
| | | | | (E1 + E2)/ | | production | |
| Sample | | E1/E2 | E1 + E2 | Si | (E1 + E2)/C | method | Remarks |
| No. | — | — | Mass % | — | — | — | — |
| No. 81 | Example | 1.00 | 0.10 | 0.12 | 0.35 | Pre-alloy | |
| No. 82 | Example | 0.90 | 0.19 | 0.26 | 0.61 | Pre-alloy | |
| No. 83 | Example | 1.33 | 0.07 | 0.14 | 0.15 | Pre-alloy | |
| No. 84 | Example | 0.27 | 0.14 | 0.15 | 0.60 | Pre-alloy | |
| No. 85 | Example | 1.50 | 0.25 | 0.32 | 0.49 | Pre-alloy | |
| No. 86 | Example | 0.29 | 0.31 | 0.76 | 0.74 | Pre-alloy | |
| No. 87 | Comp. | 0.00 | 0.05 | 0.05 | 0.12 | Pre-alloy | |
| | Ex. | | | | | | |
| No. 88 | Comp. | — | 0.06 | 0.08 | 0.16 | Pre-alloy | |
| | Ex. | | | | | | |
| No. 89 | Comp. | 7.11 | 0.83 | 0.83 | 1.32 | Pre-alloy | |
| | Ex. | | | | | | |
| No. 90 | Comp. | 0.07 | 0.61 | 1.61 | 2.09 | Pre-alloy | |
| | Ex. | | | | | | |

In Table 13, among the metal powders for powder metallurgy and the sintered bodies of the respective sample Nos., those corresponding to the invention are denoted by “Example”, and those not corresponding to the invention are denoted by “Comp. Ex.” (Comparative Example).

Each sintered body contained very small amounts of impurities, but the description thereof in Table 13 is omitted.

8. Evaluation of Sintered Body (Nb—Ta based)

### 8.1 Evaluation of Relative Density

With respect to the sintered bodies of the respective sample Nos. shown in Table 13, the sintered density was measured in accordance with the method for measuring the density of sintered metal materials specified in JIS Z 2501 (2000), and also the relative density of each sintered body was calculated with reference to the true density of the metal powder for powder metallurgy used for producing each sintered body.

The calculation results are shown in Table 14.

### 8.2 Evaluation of Hardness

With respect to the sintered bodies of the respective sample Nos. shown in Table 13, the Vickers hardness was measured in accordance with the Vickers hardness test method specified in JIS Z 2244 (2009).

Then, the measured hardness was evaluated according to the evaluation criteria described in 2.2.

The evaluation results are shown in Table 14.

### 8.3 Evaluation of Tensile Strength, 0.2% Proof Stress, and Elongation

With respect to the sintered bodies of the respective sample Nos. shown in Table 13, the tensile strength, 0.2% proof stress, and elongation were measured in accordance with the metal material tensile test method specified in JIS Z 2241 (2011).

Then, the measured values of the physical properties were evaluated according to the evaluation criteria described in 2.3.

The evaluation results are shown in Table 14.

TABLE 14

| | | Metal | | | | | |
|---|---|---|---|---|---|---|---|
| | | powder | Evaluation results of sintered body | | | | |
| | | Average | | | | 0.2% | |
| | | particle | Relative | Vickers | Tensile | proof | |
| | | diameter | density | hardness | strength | stress | Elongation |
| Sample No. | — | μm | % | — | — | — | — |
| No. 81 | Example | 4.02 | 99.3 | A | A | A | A |
| No. 82 | Example | 6.77 | 99.2 | A | A | A | A |
| No. 83 | Example | 3.64 | 99.0 | A | A | A | B |
| No. 84 | Example | 2.05 | 99.1 | A | B | B | A |
| No. 85 | Example | 14.9 | 99.0 | A | B | B | B |
| No. 86 | Example | 9.36 | 98.8 | A | B | B | C |
| No. 87 | Comp. | 4.18 | 97.1 | C | D | D | C |
| | Ex. | | | | | | |
| No. 88 | Comp. | 5.06 | 97.5 | C | D | D | C |
| | Ex. | | | | | | |
| No. 89 | Comp. | 4.22 | 96.2 | C | D | D | E |
| | Ex. | | | | | | |
| No. 90 | Comp. | 4.88 | 96.0 | C | D | D | E |
| | Ex. | | | | | | |

As apparent from Table 14, it was confirmed that the sintered bodies corresponding to Example each have a higher relative density than the sintered bodies corresponding to Comparative Example. It was also confirmed that there is a significant difference in properties such as tensile strength, 0.2% proof stress, and elongation between the sintered bodies corresponding to Example and the sintered bodies corresponding to Comparative Example.

### 9. Production of Sintered Body (Y—Nb Based)

### Sample Nos. 91 to 101

Sintered bodies were obtained in the same manner as the method for producing the sintered body of sample No. 1 except that the composition and the like of the metal powder for powder metallurgy were changed as shown in Table 15, respectively.

TABLE 15

| | | Metal powder for powder metallurgy | | | | | | | | | |
|---|---|---|---|---|---|---|---|---|---|---|---|
| | | Alloy composition | | | | | | | | | |
| | | | | | | E1 | E2 | | | | |
| Sample | | Cr | Ni | Si | C | (Y) | (Nb) | Fe | W | B | Co |
| No. | — | | Mass % | | | | | | | | |
| No. 91 | Example | 28.89 | 10.15 | 0.79 | 0.412 | 0.08 | 0.06 | 1.09 | 7.15 | 0.007 | Remainder |
| No. 92 | Example | 28.15 | 9.32 | 0.85 | 0.265 | 0.05 | 0.05 | 0.95 | 7.48 | 0.005 | Remainder |
| No. 93 | Example | 27.87 | 11.13 | 0.74 | 0.305 | 0.07 | 0.10 | 1.48 | 6.63 | 0.006 | Remainder |
| No. 94 | Example | 30.66 | 8.75 | 0.52 | 0.492 | 0.08 | 0.03 | 0.82 | 8.56 | 0.002 | Remainder |
| No. 95 | Example | 29.63 | 9.78 | 0.93 | 0.225 | 0.04 | 0.11 | 1.26 | 7.09 | 0.005 | Remainder |
| No. 96 | Example | 29.74 | 10.48 | 0.77 | 0.546 | 0.23 | 0.10 | 1.06 | 7.15 | 0.000 | Remainder |
| No. 97 | Example | 30.26 | 10.85 | 0.43 | 0.451 | 0.07 | 0.22 | 1.21 | 7.74 | 0.007 | Remainder |
| No. 98 | Comp. | 29.42 | 10.12 | 0.92 | 0.425 | 0.00 | 0.07 | 1.08 | 7.35 | 0.006 | Remainder |
| | Ex. | | | | | | | | | | |
| No. 99 | Comp. | 28.71 | 9.87 | 0.79 | 0.384 | 0.06 | 0.00 | 1.32 | 6.78 | 0.003 | Remainder |
| | Ex. | | | | | | | | | | |
| No. 100 | Comp. | 29.06 | 10.45 | 0.85 | 0.554 | 0.64 | 0.12 | 0.89 | 7.58 | 0.005 | Remainder |
| | Ex. | | | | | | | | | | |
| No. 101 | Comp. | 29.08 | 9.96 | 0.65 | 0.356 | 0.08 | 0.69 | 1.42 | 7.68 | 0.006 | Remainder |
| | Ex. | | | | | | | | | | |

| | | Metal powder for powder metallurgy | | | | | |
|---|---|---|---|---|---|---|---|
| | | | | | | Powder | |
| | | | | (E1 + E2)/ | | production | |
| Sample | | E1/E2 | E1 + E2 | Si | (E1 + E2)/C | method | Remarks |
| No. | — | — | Mass % | — | — | — | — |
| No. 91 | Example | 1.33 | 0.14 | 0.18 | 0.34 | Pre-alloy | |
| No. 92 | Example | 1.00 | 0.10 | 0.12 | 0.38 | Pre-alloy | |
| No. 93 | Example | 0.70 | 0.17 | 0.23 | 0.56 | Pre-alloy | |
| No. 94 | Example | 2.67 | 0.11 | 0.21 | 0.22 | Pre-alloy | |
| No. 95 | Example | 0.36 | 0.15 | 0.16 | 0.67 | Pre-alloy | |
| No. 96 | Example | 2.30 | 0.33 | 0.43 | 0.60 | Pre-alloy | |
| No. 97 | Example | 0.32 | 0.29 | 0.67 | 0.64 | Pre-alloy | |
| No. 98 | Comp. | 0.00 | 0.07 | 0.08 | 0.16 | Pre-alloy | |
| | Ex. | | | | | | |
| No. 99 | Comp. | — | 0.06 | 0.08 | 0.16 | Pre-alloy | |
| | Ex. | | | | | | |
| No. 100 | Comp. | 5.33 | 0.76 | 0.89 | 1.37 | Pre-alloy | |
| | Ex. | | | | | | |
| No. 101 | Comp. | 0.12 | 0.77 | 1.18 | 2.16 | Pre-alloy | |
| | Ex. | | | | | | |

In Table 15, among the metal powders for powder metallurgy and the sintered bodies of the respective sample Nos., those corresponding to the invention are denoted by “Example”, and those not corresponding to the invention are denoted by “Comp. Ex.” (Comparative Example).

Each sintered body contained very small amounts of impurities, but the description thereof in Table 15 is omitted.

### 10. Evaluation of Sintered Body (Y—Nb Based)

### 10.1 Evaluation of Relative Density

With respect to the sintered bodies of the respective sample Nos. shown in Table 15, the sintered density was measured in accordance with the method for measuring the density of sintered metal materials specified in JIS Z 2501 (2000), and also the relative density of each sintered body was calculated with reference to the true density of the metal powder for powder metallurgy used for producing each sintered body.

The calculation results are shown in Table 16.

### 10.2 Evaluation of Hardness

With respect to the sintered bodies of the respective sample Nos. shown in Table 15, the Vickers hardness was measured in accordance with the Vickers hardness test method specified in JIS Z 2244 (2009).

Then, the measured hardness was evaluated according to the evaluation criteria described in 2.2.

The evaluation results are shown in Table 16.

### 10.3 Evaluation of Tensile Strength, 0.2% Proof Stress, and Elongation

With respect to the sintered bodies of the respective sample Nos. shown in Table 15, the tensile strength, 0.2% proof stress, and elongation were measured in accordance with the metal material tensile test method specified in JIS Z 2241 (2011).

Then, the measured values of the physical properties were evaluated according to the evaluation criteria described in 2.3.

The evaluation results are shown in Table 16.

TABLE 16

| | | Metal | | | | | |
|---|---|---|---|---|---|---|---|
| | | powder | Evaluation results of sintered body | | | | |
| | | Average | | | | 0.2% | |
| | | particle | Relative | Vickers | Tensile | proof | |
| | | diameter | density | hardness | strength | stress | Elongation |
| Sample No. | — | μm | % | — | — | — | — |
| No. 91 | Example | 4.59 | 99.4 | A | A | A | A |
| No. 92 | Example | 4.13 | 99.3 | A | A | A | A |
| No. 93 | Example | 6.82 | 99.2 | A | B | B | A |
| No. 94 | Example | 3.54 | 99.0 | A | B | B | B |
| No. 95 | Example | 1.98 | 99.1 | A | B | B | A |
| No. 96 | Example | 15.6 | 98.9 | A | B | B | B |
| No. 97 | Example | 10.1 | 98.7 | A | B | B | B |
| No. 98 | Comp. Ex. | 4.15 | 96.9 | C | D | D | C |
| No. 99 | Comp. Ex. | 5.26 | 97.2 | C | C | C | B |
| No. 100 | Comp. Ex. | 4.17 | 96.1 | C | D | D | E |
| No. 101 | Comp. Ex. | 3.87 | 95.8 | C | D | D | E |

As apparent from Table 16, it was confirmed that the sintered bodies corresponding to Example each have a higher relative density than the sintered bodies corresponding to Comparative Example. It was also confirmed that there is a significant difference in properties such as tensile strength, 0.2% proof stress, and elongation between the sintered bodies corresponding to Example and the sintered bodies corresponding to Comparative Example.

### 11. Production of Sintered Body (V—Nb Based)

### Sample Nos. 102 to 111

Sintered bodies were obtained in the same manner as the method for producing the sintered body of sample No. 1 except that the composition and the like of the metal powder for powder metallurgy were changed as shown in Table 17, respectively.

TABLE 17

| | | Metal powder for powder metallurgy | | | | | | | | | |
|---|---|---|---|---|---|---|---|---|---|---|---|
| | | Alloy composition | | | | | | | | | |
| | | | | | | E1 | E2 | | | | |
| Sample | | Cr | Ni | Si | C | (V) | (Nb) | Fe | W | B | Co |
| No. | — | | Mass % | | | | | | | | |
| No. 102 | Example | 28.06 | 9.42 | 0.84 | 0.336 | 0.05 | 0.06 | 0.95 | 7.48 | 0.007 | Remainder |
| No. 103 | Example | 27.54 | 11.35 | 0.71 | 0.311 | 0.09 | 0.11 | 1.48 | 6.63 | 0.005 | Remainder |
| No. 104 | Example | 30.66 | 8.79 | 0.53 | 0.492 | 0.11 | 0.07 | 0.85 | 8.81 | 0.003 | Remainder |
| No. 105 | Example | 29.63 | 9.91 | 0.97 | 0.245 | 0.04 | 0.11 | 1.39 | 7.14 | 0.005 | Remainder |
| No. 106 | Example | 29.85 | 10.45 | 0.77 | 0.518 | 0.18 | 0.11 | 1.01 | 7.03 | 0.000 | Remainder |
| No. 107 | Example | 30.18 | 10.85 | 0.45 | 0.431 | 0.07 | 0.22 | 1.21 | 7.86 | 0.008 | Remainder |
| No. 108 | Comp. | 29.43 | 10.12 | 0.93 | 0.423 | 0.00 | 0.06 | 1.04 | 7.28 | 0.004 | Remainder |
| | Ex. | | | | | | | | | | |
| No. 109 | Comp. | 28.69 | 9.87 | 0.76 | 0.378 | 0.06 | 0.00 | 1.25 | 6.85 | 0.003 | Remainder |
| | Ex. | | | | | | | | | | |
| No. 110 | Comp. | 29.14 | 10.32 | 0.88 | 0.557 | 0.66 | 0.15 | 0.94 | 7.58 | 0.005 | Remainder |
| | Ex. | | | | | | | | | | |
| No. 111 | Comp. | 28.89 | 9.86 | 0.63 | 0.356 | 0.05 | 0.64 | 1.43 | 7.65 | 0.006 | Remainder |
| | Ex. | | | | | | | | | | |

| | | Metal powder for powder metallurgy | | | | | |
|---|---|---|---|---|---|---|---|
| | | | | | | Powder | |
| | | | | (E1 + E2)/ | | production | |
| Sample | | E1/E2 | E1 + E2 | Si | (E1 + E2)/C | method | Remarks |
| No. | — | — | Mass % | — | — | — | — |
| No. 102 | Example | 0.83 | 0.11 | 0.13 | 0.33 | Pre-alloy | |
| No. 103 | Example | 0.82 | 0.20 | 0.28 | 0.64 | Pre-alloy | |
| No. 104 | Example | 1.57 | 0.18 | 0.34 | 0.37 | Pre-alloy | |
| No. 105 | Example | 0.36 | 0.15 | 0.15 | 0.61 | Pre-alloy | |
| No. 106 | Example | 1.64 | 0.29 | 0.38 | 0.56 | Pre-alloy | |
| No. 107 | Example | 0.32 | 0.29 | 0.64 | 0.67 | Pre-alloy | |
| No. 108 | Comp. | 0.00 | 0.06 | 0.06 | 0.14 | Pre-alloy | |
| | Ex. | | | | | | |
| No. 109 | Comp. | — | 0.06 | 0.08 | 0.16 | Pre-alloy | |
| | Ex. | | | | | | |
| No. 110 | Comp. | 4.40 | 0.81 | 0.92 | 1.45 | Pre-alloy | |
| | Ex. | | | | | | |
| No. 111 | Comp. | 0.08 | 0.69 | 1.10 | 1.94 | Pre-alloy | |
| | Ex. | | | | | | |

In Table 17, among the metal powders for powder metallurgy and the sintered bodies of the respective sample Nos., those corresponding to the invention are denoted by “Example”, and those not corresponding to the invention are denoted by “Comp. Ex.” (Comparative Example).

Each sintered body contained very small amounts of impurities, but the description thereof in Table 17 is omitted.

### 12. Evaluation of Sintered Body (V—Nb Based)

### 12.1 Evaluation of Relative Density

With respect to the sintered bodies of the respective sample Nos. shown in Table 17, the sintered density was measured in accordance with the method for measuring the density of sintered metal materials specified in JIS Z 2501 (2000), and also the relative density of each sintered body was calculated with reference to the true density of the metal powder for powder metallurgy used for producing each sintered body.

The calculation results are shown in Table 18.

### 12.2 Evaluation of Hardness

With respect to the sintered bodies of the respective sample Nos. shown in Table 17, the Vickers hardness was measured in accordance with the Vickers hardness test method specified in JIS Z 2244 (2009).

Then, the measured hardness was evaluated according to the evaluation criteria described in 2.2.

The evaluation results are shown in Table 18.

### 12.3 Evaluation of Tensile Strength, 0.2% Proof Stress, and Elongation

With respect to the sintered bodies of the respective sample Nos. shown in Table 17, the tensile strength, 0.2% proof stress, and elongation were measured in accordance with the metal material tensile test method specified in JIS Z 2241 (2011).

Then, the measured values of the physical properties were evaluated according to the evaluation criteria described in 2.3.

The evaluation results are shown in Table 18.

TABLE 18

| | | Metal | | | | | |
|---|---|---|---|---|---|---|---|
| | | powder | Evaluation results of sintered body | | | | |
| | | Average | | | | 0.2% | |
| | | particle | Relative | Vickers | Tensile | proof | |
| | | diameter | density | hardness | strength | stress | Elongation |
| Sample No. | — | μm | % | — | — | — | — |
| No. 102 | Example | 4.29 | 99.2 | A | A | A | A |
| No. 103 | Example | 7.21 | 99.1 | A | A | A | B |
| No. 104 | Example | 3.07 | 98.9 | A | B | B | B |
| No. 105 | Example | 1.88 | 99.1 | A | B | B | A |
| No. 106 | Example | 13.6 | 98.8 | A | B | B | B |
| No. 107 | Example | 8.57 | 98.9 | A | B | B | B |
| No. 108 | Comp. Ex. | 4.22 | 97.1 | C | D | D | C |
| No. 109 | Comp. Ex. | 5.26 | 97.5 | C | D | D | C |
| No. 110 | Comp. Ex. | 3.68 | 96.2 | C | D | D | E |
| No. 111 | Comp. Ex. | 4.25 | 96.0 | C | D | D | E |

As apparent from Table 18, it was confirmed that the sintered bodies corresponding to Example each have a higher relative density than the sintered bodies corresponding to Comparative Example. It was also confirmed that there is a significant difference in properties such as tensile strength, 0.2% proof stress, and elongation between the sintered bodies corresponding to Example and the sintered bodies corresponding to Comparative Example.

Sintered bodies were produced in the same manner as described above also for Ti—Zr based, Zr—Ta based, and Zr—V based metal powders as examples of the combination of the first element with the second element other than the examples shown in Tables 1 to 18, and each of these sintered bodies showed the same tendency as described above with respect to the relative density, hardness, tensile strength, proof stress, and elongation.

What is claimed is:

1. A metal powder for powder metallurgy, comprising:
Co as a principal component;
Cr in a proportion of 25 mass % or more and 32 mass % or less;
Ni in a proportion of 5 mass % or more and 15 mass % or less;
Fe in a proportion of 0.5 mass % or more and 2 mass % or less;
W in a proportion of 4 mass % or more and 10 mass % or less;
Si in a proportion of 0.3 mass % or more and 1.5 mass % or less; and
C in a proportion of 0.05 mass % or more and 0.8 mass % or less, wherein
when one element selected from the group consisting of Ti, V, Y, Zr, Nb, Hf, and Ta is defined as a first element, and one element selected from the group consisting of Ti, V, Y, Zr, Nb, Hf, and Ta, and having a higher group number in the periodic table than that of the first element or having the same group number in the periodic table as that of the first element and a higher period number in the periodic table than that of the first element is defined as a second element,
the first element is contained in a proportion of 0.01 mass % or more and 0.5 mass % or less, and
the second element is contained in a proportion of 0.01 mass % or more and 0.5 mass % or less.

2. The metal powder for powder metallurgy according to claim 1, further comprising B in a proportion of 0.002 mass % or more and 0.1 mass % or less.

3. The metal powder for powder metallurgy according to claim 1, wherein when a value obtained by dividing the content E1 of the first element by the mass number of the first element is represented by X1 and a value obtained by dividing the content E2 of the second element by the mass number of the second element is represented by X2, X1/X2 is 0.3 or more and 3 or less.

4. The metal powder for powder metallurgy according to claim 1, wherein the sum of the content of the first element and the content of the second element is 0.05 mass % or more and 0.6 mass % or less.

5. The metal powder for powder metallurgy according to claim 1, wherein the metal powder has an average particle diameter of 0.5 μm or more and 30 μm or less.

6. A compound comprising the metal powder for powder metallurgy according to claim 1 and a binder which binds the particles of the metal powder for powder metallurgy to one another.

7. A compound comprising the metal powder for powder metallurgy according to claim 2 and a binder which binds the particles of the metal powder for powder metallurgy to one another.

8. A compound comprising the metal powder for powder metallurgy according to claim 3 and a binder which binds the particles of the metal powder for powder metallurgy to one another.

9. A compound comprising the metal powder for powder metallurgy according to claim 4 and a binder which binds the particles of the metal powder for powder metallurgy to one another.

10. A compound comprising the metal powder for powder metallurgy according to claim 5 and a binder which binds the particles of the metal powder for powder metallurgy to one another.

11. A granulated powder comprising the metal powder for powder metallurgy according to claim 1.

12. A granulated powder comprising the metal powder for powder metallurgy according to claim 2.

13. A granulated powder comprising the metal powder for powder metallurgy according to claim 3.

14. A granulated powder comprising the metal powder for powder metallurgy according to claim 4.

15. A granulated powder comprising the metal powder for powder metallurgy according to claim 5.

16. A sintered body comprising:
Co as a principal component;
Cr in a proportion of 25 mass % or more and 32 mass % or less;
Ni in a proportion of 5 mass % or more and 15 mass % or less;
Fe in a proportion of 0.5 mass % or more and 2 mass % or less;
W in a proportion of 4 mass % or more and 10 mass % or less;
Si in a proportion of 0.3 mass % or more and 1.5 mass % or less; and
C in a proportion of 0.05 mass % or more and 0.8 mass % or less, wherein
when one element selected from the group consisting of Ti, V, Y, Zr, Nb, Hf, and Ta is defined as a first element, and one element selected from the group consisting of Ti, V, Y, Zr, Nb, Hf, and Ta, and having a higher group number in the periodic table than that of the first element or having the same group number in the periodic table as that of the first element and a higher period number in the periodic table than that of the first element is defined as a second element,
the first element is contained in a proportion of 0.01 mass % or more and 0.5 mass % or less, and
the second element is contained in a proportion of 0.01 mass % or more and 0.5 mass % or less.

17. A heat resistant component comprising the sintered body according to claim 8.

18. The heat resistant component according to claim 9, wherein the heat resistant component is a supercharger component, a jet engine component, or a power generation turbine component.
